(19) United States
(12) Patent Application Publication
(10) Pub. No.: US 2025/0086855 A1
(43) Pub. Date: Mar. 13, 2025

(54) SYSTEMS AND METHODS FOR INTERPOLATING HIGH-RESOLUTION TEXTURES BASED ON FACIAL EXPRESSIONS

(71) Applicant: Digital Domain Virtual Human (US), Inc., Los Angeles, CA (US)

(72) Inventors: Rishabh BATTULWAR, Santa Clara, CA (US); Lucio Dorneles MOSER, Vancouver (CA)

(73) Assignee: Digital Domain Virtual Human (US), Inc., Los Angeles, CA (US)

(21) Appl. No.: 18/956,306

(22) Filed: Nov. 22, 2024

Related U.S. Application Data
(63) Continuation of application No. PCT/CA2022/050882, filed on Jun. 2, 2022.

(51) Int. Cl. G06T 11/00; G06T 3/4007

(52) U.S. Cl. CPC G06T 11/001; G06T 3/4007

(57) ABSTRACT

A method for determining a texture for a target expression comprises: determining feature graphs for the target expression and each of P training poses; determining blending weights tᵥ based on: an approximation model trained using the training poses and a similarity metric ϕ^{v,t} representing a similarity of the target feature graph at a vertex v to each of the training feature graphs; for each pixel in a plurality of 2D pixels: determining one or more vertices that correspond with the pixel based on 2D coordinates of the pixel and a mapping of the vertices to 2D; and determining per-pixel blending weights rₙ for the pixel based on the blending weights tᵥ for the corresponding vertices. The method also comprises, for each high-resolution pixel in a 2D rendering of the target facial expression, interpolating 2D textures of the training facial poses based on the per-pixel blending weights rₙ to thereby provide the target texture.

### REFERENCE TO RELATED APPLICATIONS

This application is a continuation of Patent Cooperation Treaty (PCT) application No. PCT/CA2022/050882 filed 2 Jun. 2022, which is hereby incorporated herein by reference.

### TECHNICAL FIELD

This invention relates generally to computer animation, and more particularly to systems and methods for rendering, in real-time, photo-realistic faces with animated skin textures based on the interpolation of textures from known facial expressions.

### BACKGROUND

Rendering, in general, means creating an image from a computer-based model. Animation typically involves a series of images (frames) shown at a frame rate that is sufficient to give the appearance that objects and characters are moving. In facial animation, rendering often involves creating a two-dimensional (2D) image from a three-dimensional (3D) model. Producing high-resolution facial renders (e.g. for use in animated feature films) according to current techniques generally requires first scanning an actor's face using appropriate facial capture technology. To achieve the photorealism and complexity in the look and feel of the character's skin in a corresponding facial rendering, a number of scans of the actor's face are typically obtained with various detailed skin information, or textures, such as albedo, diffuse and specular values, taken from various illumination conditions.

Shaders are computer programs which compute the appearance of the digital materials based on the incoming light, viewing direction and properties of the material, such as albedo, diffuse, specular, and/or the like, typically available as a texture map, or as vertex attributes. Shaders can be used to apply various attributes and traits specific to certain vertices (e.g. in 3D facial models) and/or corresponding rendered pixels (in rendered 2D images). Rendering of animation frames typically occurs “offline” (where many image frames are rendered in advance of displaying the corresponding images) or in “real time” (where image frames are rendered between the display of successive corresponding images). Similarly, shader programs exist for offline applications and real-time applications. Offline shaders are typically executed by one or more general purpose central processing units (CPUs) and real-time shaders are typically executed by one or more graphics-specific graphics processing units (GPUs).

High-resolution textures may be captured prior to rendering for several different facial expressions. Sometimes a number on the order of 12 different texture types are captured on a number on the order of 20 different facial expressions (also referred to herein as poses). This resulting dataset is large and necessarily results in correspondingly high computational expense for the processor executing the shader software and a correspondingly large computation time for rendering a final set of images for the animation. Furthermore, the pose (facial expression) associated with a rendered frame (the rendered pose) will typically be different than any of the captured poses. One reason for the high computational demand associated with shading is that the shaders are typically required to blend or interpolate the textures from a number of captured poses in the dataset, so that the final interpolated textures generate an accurate representation of the skin for the current rendered pose. This large computational expense can be an issue, particularly for real-time applications, where frame rates can be 6 fps, 12 fps, 30 fps, 60 fps or higher.

Additionally, prior art solutions used for rendering faces in animated feature films are usually geared towards controllability to achieve a desired, art-directed result. Allowance for further processing necessarily increases the file size and storage demands of resulting renders produced by the shader.

Several approaches for providing real-time facial renders have been proposed. One approach is to compute a single scalar representing levels of skin stretching/compression at each vertex of a parameterized facial model (e.g. a 3D CG model). That single value can then be used in the shader to blend textures from a number of poses (explained below) at image pixels associated with that vertex. In its simplest form, this method requires three input poses, one in a relaxed or neutral state, one in a maximally stretched state, and one in a maximally compressed state. The shader is then able to use the compression ratio and blend the textures of these poses at render time with polynomial or spline equations.

One drawback of such an approach is that, apart from the neutral state texture, the other two textures (maximally stretched and maximally compressed) cannot be directly captured from actors' skin, as it is impossible to fully compress or stretch the face in all areas at the same time. Therefore, these textures must be carefully “painted” or otherwise created by skilled artists. Furthermore, skin can undergo other kinds of stress, such as twists and asymmetric stretching and compression in orthogonal directions. This prior art real-time shading solution therefore does now allow for realistic skin reproduction in those scenarios.

Another prior art real-time rendering approach is to drive the textures based on a pre-defined set of key poses, called blendshapes. Suitably weighted sets of blendshapes can be used to approximate a wide range of 3D model poses. With such prior art techniques, a facial rendering is produced by selecting two or more of the most relevant poses (blendshapes) and interpolating the textures proportional to the activation (weights) of the corresponding blendshapes. In this solution, all possible blendshape poses must be captured and results in a large number of blendshape poses and textures, typically around 100-200. Many textures would be redundant as blendshapes are usually localized, such as the lips moving forward, while other features stay neutral. The results produced by this method may be desirable if the goals were to achieve art-directed results, but this method is often too inefficient for real-time applications.

Some prior art approaches for producing facial renders (typically offline facial renders) follow the Facial Action Coding System (FACS), which encodes muscle specific shapes. These muscle shapes are called action units, or AUs, and can be used to encode nearly any anatomically possible facial expression. It is possible to associate one texture per FACS shape and use the same AU activation weights to drive the blending for the textures. As an example, basic emotions can be defined in relation to a combination of multiple AUs and the weights of those AUs can be imported to a computer facial rendering model for deriving a set of animated textures.

Other rendering approaches exist which use regression models to predict wrinkle formation on patches of the face based on overall, large-scale facial appearance. However, such approaches focus solely on textures related to specific portions of the face producing the wrinkles. Such regression models find interpolation weights for a number of texture patches and, consequently, require a separate step of blending of all patches. These approaches tend to be specifically crafted for each actor and involve an artist creating the blending setup or segmentation of the face into patches.

There remains a need for facial rendering techniques and systems which can represent facial texture changes due to patterns of deformation from a limited set of scanned facial poses which improve upon the prior art techniques and/or ameliorate some of these or other drawbacks with prior art techniques. There is a particular desire for real-time facial rendering techniques.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect of the invention provides a method for determining a high-resolution texture for rendering a target facial expression. The method comprises: (a) obtaining a plurality of P training facial poses, each of the P training facial poses comprising: V high-resolution vertices and training-pose positions of the V high-resolution vertices in a three-dimensional (3D) coordinate system; and at least one two-dimensional (2D) texture; (b) obtaining a target facial expression, the target facial expression comprising the Vhigh-resolution vertices and target-expression positions of the Vhigh-resolution vertices in the 3D coordinate system; (c) determining a target feature graph comprising a plurality of target feature graph parameters for the target facial expression based at least in part on the target facial expression and a neutral pose selected from among the P training poses; (d) determining training feature graphs comprising pluralities of training feature graph parameters for the P training facial poses, each of the training feature graphs based at least in part on one of the P training facial poses and the neutral pose; (e) for each of a plurality of high-resolution vertices v from among the Vhigh-resolution vertices, determining a plurality of blending weights tᵥ based at least in part on: an approximation model trained using the P training facial poses; and a similarity metric ϕ^{v,t} which represents a similarity of the target feature graph at the vertex v to each of the training feature graphs; (f) for each pixel n in a plurality of N pixels in a 2D space: (f. 1) determining one or more corresponding vertices from among the plurality of high-resolution vertices v that correspond with the pixel n based at least in part on 2D coordinates of the pixel n in the 2D space and a mapping of the plurality of high-resolution vertices v to the 2D space which provides 2D coordinates of the plurality of high-resolution vertices v in the 2D space; and (f.2) determining a set of per-pixel blending weights rₙ for the pixel n based at least in part on the blending weights tᵥ for the one or more corresponding vertices, the set of per-pixel blending weights rₙ comprising a weight for each of the P training facial poses; and (g) for each high-resolution pixel in a 2D rendering of the target facial expression, interpolating the 2D textures of the P training facial poses based at least in part on the per-pixel blending weights rₙ to thereby provide a target texture for the high-resolution pixel.

Determining the training feature graphs for the P training poses may comprise determining a plurality of W low-resolution handle vertices, where the W handle vertices are a low-resolution subset of the Vhigh-resolution vertices where W<V.

Determining the training feature graphs for the P training poses may comprise, for each of the P training facial poses: determining a training feature graph geometry corresponding to the training facial pose, the training feature graph geometry comprising a plurality of F feature edges defined between the training-pose positions of corresponding pairs of the plurality of low-resolution W handle vertices for the training pose; determining the plurality of training feature graph parameters to be a plurality of F training feature graph parameters corresponding to the F feature edges, each of the plurality of F training feature graph parameters based at least in part on the corresponding feature edge of the training facial pose and the corresponding feature edge of the neutral pose; to thereby obtain the P training feature graphs, each of the P training feature graphs comprising a corresponding plurality of F training feature graph parameters.

Determining the plurality of F training feature graph parameters corresponding to the F feature edges may comprise, for each of the plurality of F training feature graph parameters, determining the training feature graph parameter using an equation of the form

$${f}_{i} = ( ‖ {p}_{i , 1} - {p}_{i , 2} ‖ - {l}_{i} ) / {l}_{i} \qquad ( 1 )$$

where: ƒᵢ is the i^{th} training feature graph parameter corresponding to the i^{th} feature edge; p_{i,1} and p_{i,2} are the training-pose positions of the handle vertices that define endpoints of ƒᵢ; and lᵢ is a length of the corresponding i^{th} feature edge in the neutral pose.

Determining the training feature graphs for the P training poses may comprise, for each of the P training facial poses: determining a training feature graph geometry corresponding to the training facial pose, the training feature graph geometry comprising a plurality of F feature edges defined between the training-pose positions of corresponding pairs of the plurality of low-resolution W handle vertices for the training pose; determining the plurality of training feature graph parameters, each of the plurality of training feature graph parameters based at least in part on some or all of the F feature edges of the training facial pose and some or all of the feature edges of the neutral pose; to thereby obtain the P training feature graphs, each of the P training feature graphs comprising a corresponding plurality of training feature graph parameters.

determining the training feature graphs for the P training poses may comprise, for each of the P training facial poses: determining the plurality of training feature graph parameters, each of the plurality of training graph feature parameters based at least in part on one or more primitive parameters determined based at least in part on the training facial pose and the neutral pose; to thereby obtain the P training feature graphs, each of the P training feature graphs comprising a corresponding plurality of training feature graph parameters.

Determining the plurality of training feature graph parameters may comprise determining one or more of: deformation gradients based at least in part on the training facial pose and the neutral pose; pyramid coordinates based at least in part on the training facial pose and the neutral pose; triangle parameters based at least in part on the training facial pose and the neutral pose; and 1-ring neighbor parameters based at least in part on the training facial pose and the neutral pose.

Determining the target feature graph may comprise: determining a target feature graph geometry corresponding to the target facial expression, the target feature graph geometry comprising a plurality of F feature edges defined between the target-expression positions of corresponding pairs of the plurality of low-resolution W handle vertices for the target expression; determining the plurality of target feature graph parameters to be a plurality of F target feature graph parameters corresponding to the F feature edges, each of the plurality of F target feature graph parameters based at least in part on the corresponding feature edge of the target facial expression and the corresponding feature edge of the neutral pose; to thereby obtain the target feature graph comprising the plurality of F target feature graph parameters.

determining the plurality of F target feature graph parameters corresponding to the F feature edges may comprise, for each of the plurality of F target feature graph parameters, determining the target feature graph parameter using an equation of the form

$${f}_{i} = ( ‖ {p}_{i , 1} - {p}_{i , 2} ‖ - {l}_{i} ) / {l}_{i} \qquad ( 1 )$$

where: ƒᵢ is the i^{th} target feature graph parameter corresponding to the i^{th} feature edge; p_{i,1} and p_{i,2} are the target-expression positions of the handle vertices that define endpoints of ƒᵢ; and lᵢ is a length of the corresponding i^{th} feature edge in the neutral pose.

Determining the target feature graph may comprise: determining a target feature graph geometry corresponding to the target facial expression, the target feature graph geometry comprising a plurality of F feature edges defined between the target-expression positions of corresponding pairs of the plurality of low-resolution W handle vertices for the target facial expression; determining the plurality of target feature graph parameters, each of the plurality of target feature graph parameters based at least in part on some or all of the F feature edges of the target facial expression and some or all of the feature edges of the neutral pose; to thereby obtain the target feature graph comprising the plurality of target feature graph parameters.

Determining the target feature graph may comprise: determining a plurality of target feature graph parameters, each of the plurality of target graph feature parameters based at least in part on one or more primitive parameters determined based on the target facial expression and the neutral pose; to thereby obtain the target feature graph comprising the plurality of target feature graph parameters.

Determining the plurality of target feature graph parameters may comprise determining one or more of: deformation gradients based at least in part on the target facial expression and the neutral pose; pyramid coordinates based at least in part on the target facial expression and the neutral pose; triangle parameters based at least in part on the target facial expression and the neutral pose; and 1-ring neighbor parameters based at least in part on the target facial expression and the neutral pose.

Determining the one or more corresponding vertices from among the plurality of high-resolution vertices v that correspond with the pixel n may be based at least in part on a proximity of the 2D coordinates of the one or more corresponding vertices to the 2D coordinates of the pixel n.

Determining the one or more corresponding vertices from among the plurality of high-resolution vertices v that correspond with the pixel n may comprise determining the three vertices with 2D coordinates most proximate to the 2D coordinates of the pixel n, to thereby define a triangle around the pixel n in the 2D space.

Determining the one or more corresponding vertices from among the plurality of high-resolution vertices v that correspond with the pixel n may comprise determining barycentric coordinates for the triangle relative to the 2D coordinates of the pixel n.

Determining the one or more corresponding vertices from among the plurality of high-resolution vertices v that correspond with the pixel n may comprise determining the one vertex with 2D coordinates most proximate to the 2D coordinates of the pixel n.

The method may comprise selecting the plurality of high-resolution vertices v from among the Vhigh-resolution vertices to be a union of the one or more high-resolution vertices determined to correspond with each pixel n in the plurality of N pixels; and wherein selecting the plurality of high-resolution vertices v from among the V high-resolution vertices is performed prior to step (e) so that step (e) is performed only for the selected plurality of high-resolution vertices v from among the Vhigh-resolution vertices.

The method may comprise selecting the plurality of high-resolution vertices v from among the Vhigh-resolution vertices to be all of the V high-resolution vertices.

Determining the set of per-pixel blending weights rₙ for the pixel n may comprise determining the set of per-pixel blending weights rₙ for the pixel n based at least in part on the blending weights tᵥ for the three vertices that define the triangle around the pixel n in the 2D space and the barycentric coordinates of the triangle relative to the 2D coordinates of the pixel n.

Determining the set of per-pixel blending weights rₙ for the pixel n may comprise performing an operation of the form rₙ=γ_{A}t_{A}+γ_{B}t_{B}+γ_{C}t_{C} where t_{A}, t_{B}, t_{C} represent the blending weights tᵥ determined in step (e) for the three vertices that define the triangle around the pixel n in the 2D space and γ_{A}, γ_{B}, γ_{C} represent the barycentric coordinates for the triangle relative to the 2D coordinates of the pixel n.

Determining the set of per-pixel blending weights rₙ for the pixel n may comprise determining the set of per-pixel blending weights rₙ for the pixel n to be the blending weights tᵥ determined in step (e) for the one vertex with 2D coordinates most proximate to the 2D coordinates of the pixel n.

The 2D space may be a 2D space of the 2D rendering.

The 2D space may be different from that of the 2D rendering. The 2D space may be a UV space.

The plurality of N pixels in the 2D space may have a resolution that is lower than that of the pixels in the 2D rendering.

Interpolating the 2D textures of the P training facial poses may be based at least in part on a location of the high-resolution pixel mapped to the 2D space.

The method may comprise determining the approximation model based at least in part on the training feature graphs of the P training facial poses.

Determining the approximation model may comprise, for each high-resolution vertex v of the Vhigh-resolution vertices: solving an equation of the form w=dϕ⁻¹ where: d is a P-dimensional identity matrix; and ϕ is a P×P dimensional matrix of weighted radial basis functions (RBFs) where each element of ϕ is based at least in part on comparing the training feature graph parameters of the P training feature graphs; to thereby obtain a P×P dimensional matrix of RBF weights w corresponding to the high-resolution vertex v; to thereby define an approximation model which comprises a set of V RBF weight matrices w.

For each high-resolution vertex v of the V high-resolution vertices, determining weights for the weighted radial basis functions (RBFs) in the matrix ϕ may be based at least in part on a proximity mask which assigns a value of unity for feature edges surrounding the vertex v and decaying values for feature edges that are further from the vertex v.

The proximity mask may assign exponentially decaying values for feature edges that are further from the vertex v.

The proximity mask may be determined according to an equation of the form:

$${α}_{v , i} = \frac{{\overline{α}}_{v , i}}{{\sum }_{i} {\overline{α}}_{v , i}} , with {\overline{α}}_{v , i} = {e}^{- β ( {L}_{v , i} - {l}_{i} )} \qquad ( 1 )$$

where: lᵢ is a length of the iₜₕ feature edge of the neutral-pose; L_{v,i} is the sum of neutral pose distances from the vertex v to the locations of endpoints of the i^{th} feature edge of the neutral-pose; and β is a configurable scalar parameter which controls a rate of decay.

The method may comprise setting the proximity mask for the i^{th} feature edge to zero if it is determined that a computed proximity mask for the i^{th} feature edge is less than a threshold value.

The proximity mask may comprise assigning non-zero values to a configurable number of feature edges that are relatively more proximate to the vertex v and zero values to other feature edges that are relatively more distal from the vertex v.

An element (ϕ_{v,k,l}) of the P×P dimensional matrix ϕ of weighted RBFs at a k^{th} column and a l^{th} row may be given by an equation of the form:

$${ϕ}_{v , k , l} = γ ( {\sum }_{i = 1}^{F} {{α}_{v , i} ( {( {f}_{k , i} - {f}_{l , i} )}^{{}_{2}} )}^{{}_{1 / 2}} \qquad ( 4 )$$

where: γ is an RBF kernel function; ƒ_{k,i} is a training feature graph parameter of the i^{th} feature edge in the k^{th} training pose; ƒ_{l,i} is a training feature graph parameter of the i^{th} feature edge of the l^{th} training pose; and α_{v,i} is a weight assigned to i^{th} feature edge based on its proximity to the high-resolution vertex v.

The RBF kernel function γ may be a biharmonic RBF kernel function.

Determining the approximation model may comprise training an approximation model to solve a sparse interpolation problem based at least in part on the training feature graph parameters of the P training feature graphs.

The method may comprise determining the similarity metric ϕ^{v,t} representing the similarity of the target feature graph at the vertex v to each of the P training feature graphs be a P dimensional similarity vector ϕ^{v,t}, where a k^{th} element (ϕₖ^{v,t}) of the similarity vector ϕ^{v,t} according to an equation of the form:

$${ϕ}_{k}^{v , t} = γ ( {\sum }_{i = 1}^{F} {{α}_{v , i} ( {( {f}_{t , i} - {f}_{k , i} )}^{{}_{2}} )}^{{}_{1 / 2}} \qquad ( 7 )$$

where: γ is an RBF kernel function; ƒ_{t,i} a target feature graph parameter of the i^{th} feature edge of the target feature graph; ƒ_{k,i} is a training feature graph parameter of the i^{th} feature edge of the training feature graph for the k^{th} training pose; α_{v,i} is a weight assigned to i^{th} feature edge based on its proximity to the high-resolution vertex v; and i (i∈1, 2, . . . F) is an index that describes the number of edges in each of the training feature graphs and the target feature graph.

Determining the plurality of blending weights tᵥ may comprise performing an operation of the form tᵥ=w·ϕ^{v,t}, where w is the RBF weight matrix for the high-resolution vertex v and ϕ^{v,t} is the P dimensional similarity vector representing the similarity of the target feature graph at the vertex v to each of the P training feature graphs.

Interpolating the 2D textures of the P training facial poses may comprise: texture querying the 2D textures of the P training facial poses based on the high-resolution pixel in the 2D rendering to obtain interpolated texture values for each of the P training facial poses (tex₁, tex₂, tex₃ . . . tex_{P}), each interpolated texture value interpolated between texture values at a plurality of texels of the 2D texture of a corresponding one of the P training facial poses; weight-texture querying the 2D space based on the high-resolution pixel in the 2D rendering to obtain a set of interpolated per-pixel blending weights r* (r₁, r₂ . . . r_{P}), which are interpolated between per-pixel blending weights rₙ of a plurality of pixels n in the 2D space.

Interpolating the 2D textures of the P training facial poses may comprise determining the target texture for the high-resolution pixel (texture) according to an equation of the form

$$texture = {tex}_{1} \cdot {r}_{1} + t e {x}_{2} \cdot {r}_{2} + … {tex}_{P} \cdot {r}_{P}$$

where: (tex₁, tex₂, tex₃ . . . tex_{P}) are the interpolated texture values for each of the P training facial poses; and (r₁, r₂ . . . r_{P}) are the set of interpolated per-pixel blending weights r*.

Texture querying the 2D textures of the P training facial poses based on the high-resolution pixel in the 2D rendering may comprise mapping the high-resolution pixel in the 2D rendering to UV space to determine 2D coordinates of the high-resolution pixel in UV space.

Weight-texture querying the 2D space based on the high-resolution pixel in the 2D rendering may comprise mapping the high-resolution pixel in the 2D rendering to the 2D space to determine 2D coordinates of the high-resolution pixel in the 2D space.

Interpolating the 2D textures of the P training facial poses may comprise: texture querying the 2D textures of the P training facial poses based on the high-resolution pixel in the 2D rendering to obtain interpolated texture values for each of the P training facial poses (tex₁, tex₂, tex₃ . . . tex_{P}), each interpolated texture value interpolated between texture values at a plurality of texels of the 2D texture of a corresponding one of the P training facial poses.

Interpolating the 2D textures of the P training facial poses comprises determining the target texture for the high-resolution pixel (texture) according to an equation of the form

$$texture = {tex}_{1} \cdot {r}_{1} + t e {x}_{2} \cdot {r}_{2} + … {tex}_{P} \cdot {r}_{P}$$

where: (tex₁, tex₂, tex₃ . . . tex_{P}) are the interpolated texture values for each of the P training facial poses; and (r₁, r₂ . . . r_{P}) are the set of interpolated per-pixel blending weights rₙ for the high-resolution pixel in the 2D space of the 2D rendering.

Texture querying the 2D textures of the P training facial poses based on the high-resolution pixel in the 2D rendering may comprise mapping the high-resolution pixel in the 2D rendering to UV space to determine 2D coordinates of the high-resolution pixel in UV space.

The method may be used to render an animation sequence comprising a plurality of animation frames corresponding to a plurality of target facial expressions at an animation frame rate. Steps (a), (d) and (f.1) may be performed for the animation sequence as a pre-computation step prior to one or more of steps (b), (c), (e), (f.2) and (g); and steps (c), (e), (f.2) and (g) may be performed in real time upon obtaining corresponding ones of the plurality of target facial expressions, as part of step (b), for the animation sequence.

The set of per-pixel blending weights rₙ for each pixel n may comprise a vector of P elements; and the method may comprise providing corresponding elements of the per-pixel blending weights rₙ to a graphics processor in color channels of one or more corresponding images having N pixels.

The method may be used to render an animation sequence comprising a plurality of animation frames corresponding to a plurality of target facial expressions at an animation frame rate. Steps (a), (d) and (f.1) may be performed for the animation sequence as a pre-computation step prior to one or more of steps (b), (c), (e), (f.2) and (g). Steps (c), (e), (f.2) and (g) may be performed in real time upon obtaining corresponding ones of the plurality of target facial expressions, as part of step (b), for the animation sequence. The set of per-pixel blending weights rₙ for each pixel n may comprise a vector of P elements. The method may comprise providing corresponding elements of the per-pixel blending weights rₙ to a graphics processor in color channels of one or more corresponding low-resolution images having N low-resolution pixels, with a resolution lower than that of the images being rendered.

The color channels of the one or more corresponding low-resolution images may comprise red, blue and green (RGB) color channels.

The plurality of P training poses may comprise a number P of training poses that is a multiple of 3.

Another aspect of the invention provides a computer-implemented method for training an approximation model for facial poses which can be used to determine a similarity of a target facial expression to a plurality of training facial poses at each high-resolution vertex v of a set of V high-resolution vertices that define a topology that is common to the target facial expression and the plurality of training facial poses. The method comprises: obtaining a plurality of P training facial poses, each of the P training facial poses comprising training-pose positions of the V high-resolution vertices in a three-dimensional (3D) coordinate system; for each of the P training facial poses: determining a training feature graph comprising a corresponding plurality of training feature graph parameters, wherein each of the corresponding plurality of training feature graph parameters is based at least in part on one or more primitive parameters determined based at least in part on the training facial pose and a neutral pose selected from among the P training poses; to thereby obtain P training feature graphs, each of the P training feature graphs comprising a corresponding plurality of training feature graph parameters; and for each high-resolution vertex v of the V high-resolution vertices: solving an equation of the form w=dϕ⁻¹ where: d is a P-dimensional identity matrix; and ϕ is a P×P dimensional matrix of weighted radial basis functions (RBFs) where each element of ϕ is based at least in part on comparing the training feature graph parameters of the P training feature graphs; to thereby obtain a P×P dimensional matrix of RBF weights w corresponding to the high-resolution vertex v, to thereby define an approximation model which comprises a set of V RBF weight matrices w.

The method may comprise determining a plurality of low-resolution W handle vertices, where the Whandle vertices are a low-resolution subset of the V high-resolution vertices where W<V.

Determining the training feature graph comprising the corresponding plurality of training feature graph parameters may comprise: determining a training feature graph geometry corresponding to the training facial pose, the training feature graph geometry comprising a plurality of F feature edges defined between the training-pose positions of corresponding pairs of the plurality of low-resolution W handle vertices for the training pose; determining the plurality of training feature graph parameters, each of the plurality of training feature graph parameters based at least in part on some or all of the F feature edges of the training facial pose and some or all of the feature edges of the neutral pose.

Determining the training feature graph comprising the corresponding plurality of training feature graph parameters may comprise: determining a training feature graph geometry corresponding to the training facial pose, the training feature graph geometry comprising a plurality of F feature edges defined between the training-pose positions of corresponding pairs of the plurality of low-resolution W handle vertices for the training pose; determining the plurality of training feature graph parameters to be a plurality of F training feature graph parameters corresponding to the F feature edges, each of the plurality of F training feature graph parameters based at least in part on the corresponding feature edge of the training facial pose and the corresponding feature edge of the neutral pose; to thereby obtain the P training feature graphs, each of the P training feature graphs comprising a corresponding plurality of F training feature graph parameters.

Determining the plurality of F training feature graph parameters corresponding to the F feature edges may comprise, for each of the plurality of F training feature graph parameters, determining the training feature graph parameter using an equation of the form

$${f}_{i} = ( ‖ {p}_{i , 1} - {p}_{i , 2} ‖ - {l}_{i} ) / {l}_{i} \qquad ( 1 )$$

where: ƒᵢ is the i^{th} training feature graph parameter corresponding to the i^{th} feature edge; p_{i,1} and p_{i,2} are the training-pose positions of the handle vertices that define endpoints of ƒᵢ; and lᵢ is a length of the corresponding i^{th} feature edge in the neutral pose.

Determining the training feature graph comprising the corresponding plurality of training feature graph parameters may comprise determining one of more of: deformation gradients based at least in part on the training facial pose and the neutral pose; pyramid coordinates based at least in part on the training facial pose and the neutral pose; triangle parameters based at least in part on the training facial pose and the neutral pose; and 1-ring neighbor parameters based at least in part on the training facial pose and the neutral pose.

For each high-resolution vertex v of the V high-resolution vertices, determining weights for the weighted radial basis functions (RBFs) in the matrix ϕ may be based at least in part on a proximity mask which assigns a value of unity for feature edges surrounding the vertex v and decaying values for feature edges that are further from the vertex v.

The proximity mask may assign exponentially decaying values for feature edges that are further from the vertex v.

The proximity mask may be determined according to an equation of the form:

$${α}_{v , i} = \frac{{\overline{α}}_{v , i}}{{\sum }_{i} {\overline{α}}_{v , i}} , with {\overline{α}}_{v , i} = {e}^{- β ( {L}_{v , i} - {l}_{i} )} \qquad ( 2 )$$

where: lᵢ is a length of the iₜₕ feature edge of the neutral-pose; L_{v,i} is the sum of neutral pose distances from the vertex v to the locations of endpoints of the i^{th} feature edge of the neutral-pose; and β is a configurable scalar parameter which controls a rate of decay.

The method may comprise setting the proximity mask for the i^{th} feature edge to zero if it is determined that a computed proximity mask for the i^{th} feature edge is less than a threshold value.

The proximity mask may comprise assigning non-zero values to a configurable number of feature edges that are relatively more proximate to the vertex v and zero values to other feature edges that are relatively more distal from the vertex v.

An element (ϕ_{v,k,l}) of the P×P dimensional matrix ϕ of weighted RBFs at a k^{th} column and a l^{th} row may be given by an equation of the form:

$${ϕ}_{v , k , l} = γ ( {\sum }_{i = 1}^{F} {{α}_{v , i} ( {( {f}_{k , i} - {f}_{l , i} )}^{{}_{2}} )}^{{}_{{}_{1 / 2}}} \qquad ( 4 )$$

where: γ is an RBF kernel function; ƒ_{k,i} is a training feature graph parameter of the i^{th} feature edge in the k^{th} training pose; ƒ_{l,i} is a training feature graph parameter of the i^{th} feature edge of the l^{th} training pose; and α_{v,i} is a weight assigned to i^{th} feature edge based on its proximity to the high-resolution vertex v.

The RBF kernel function γ may be a biharmonic RBF kernel function.

Another aspect of the invention provides a system comprising one or more processors configured to perform any of the methods described above or elsewhere herein.

In addition to the exemplary aspects and embodiments described above, further aspects and embodiments will become apparent by reference to the drawings and by study of the following detailed descriptions. It is emphasized that the invention relates to all combinations and sub-combinations of the above features and other features described herein, even if these are recited in different claims or claims with different dependencies.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is a flow chart depicting a method of interpolating high-resolution textures based on a set of facial training data according to a particular embodiment. FIG. 1A depicts an exemplary system for performing one or more methods described herein (e.g. the method of Figure and/or any of its sub-processes) according to a particular embodiment.

FIG. 2A is a flow chart depicting a method of selecting a set of relevant poses from a number of training poses and of determining their feature graph geometries according to a particular embodiment. FIG. 2B is a flow chart depicting a method of determining training pose feature graphs according to a particular embodiment.

FIG. 3A shows an example marker layout used on an actor's face. FIG. 3B shows a representation of a low-resolution 3D mesh (feature graph geometry) representation (3D model) of a face. FIG. 3C shows a representation of a high-resolution facial expression.

FIG. 4 is a flow chart depicting a method of training an approximation model according to a particular embodiment of the invention.

FIG. 5 is a flow chart depicting a method of performing a rasterization computation according to a particular embodiment of the invention.

FIG. 6A is a schematic view of an exemplary UV mapping of an example face topology and an overlaid discretization of the UV space showing the coverage of each pixel of a low-resolution weight texture map. FIG. 6B is detailed view of an example pixel (or notional cell) of the FIG. 6A UV mapping depicting the pixel in UV space (or the center of the notional cell) and surrounding vertices.

FIG. 7 is a flow chart depicting a method of performing a real-time computation for interpolating high-resolution textures according to a particular embodiment. FIG. 7A is a flow chart depicting a method for interpolating training pose weights to obtain blending weights which may be used to perform one step of the FIG. 7 method according to a particular embodiment. FIG. 7B is a flow chart depicting another method for interpolating high-resolution textures according to another particular embodiment.

FIG. 8 is an example set of weight textures represented as two RGB pixel maps.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

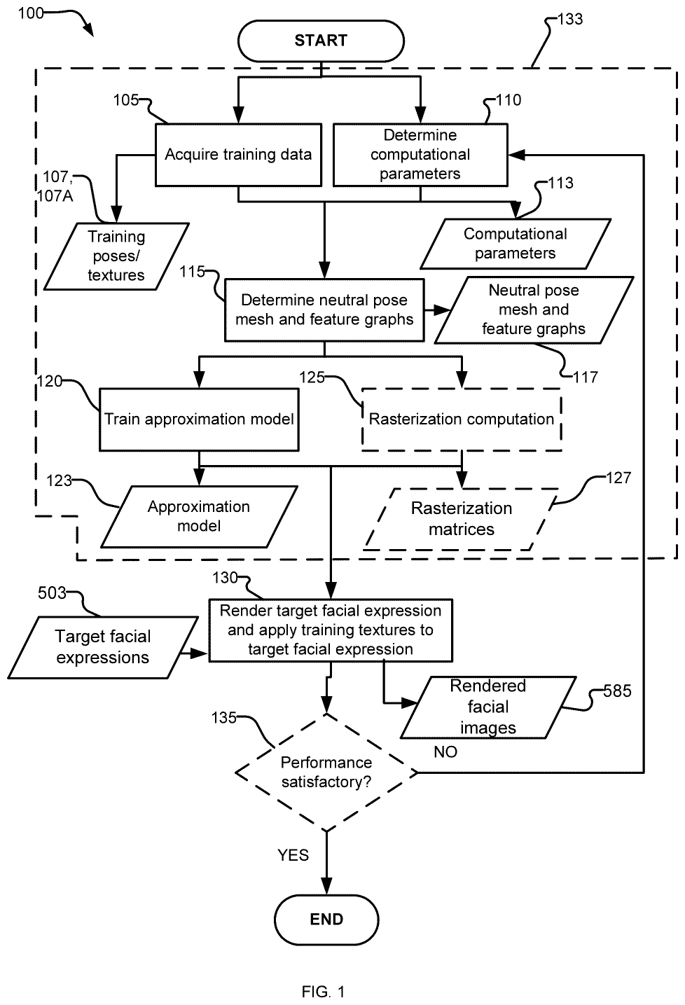

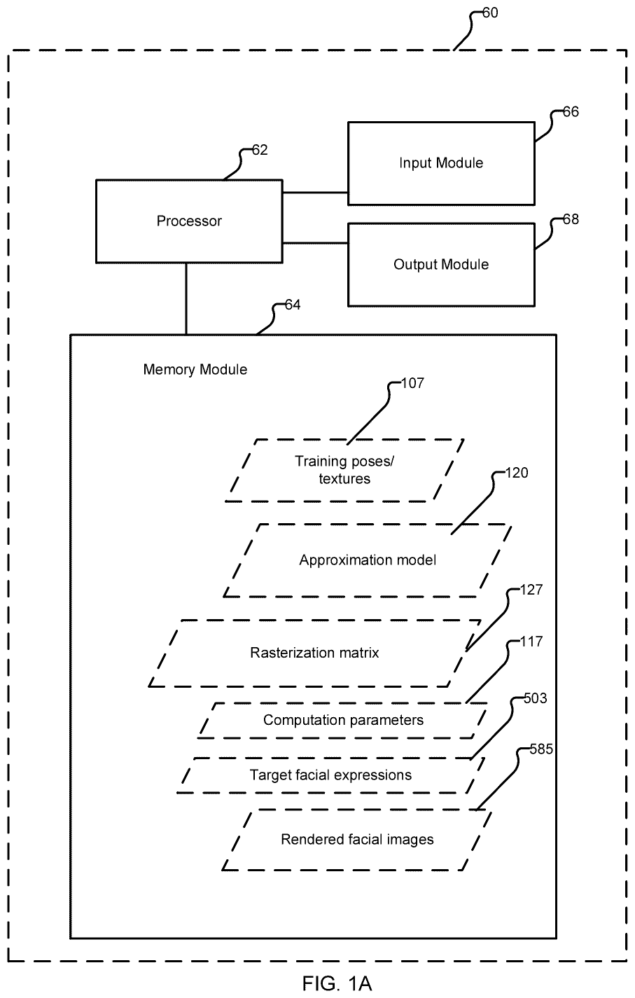

FIG. 1 schematically depicts a high-resolution facial texture interpolation method 100 according to an example embodiment of the invention. In general, method 100 comprises a training portion 133 and a rendering/interpolation portion 130. Training portion 133 of method 100 receives as input a number of training poses 107 and generates an approximation model 123 and a rasterization matrix 127. Rendering/interpolation portion 130 of method 100 interpolates between the high-resolution textures associated with training poses 107 to determine textures suitable for rendering target facial expressions 503 to provide rendered facial images 585. In some embodiments, rendering/interpolation portion 130 of method 100 is performed in real-time (e.g. in the interval between successive frames to render animation frames at a frame rate of 24 or more frames per second), while training portion 133 is performed “off-line” (i.e. not in real time). In some embodiments, method 100 is performed in accordance with computational parameters 113. Some of computational parameters 113 may be input to method 100. Some of computational parameters 113 may be determined as a part of method 100.

Some aspects of the invention provide a system 60 (an example embodiment of which is shown in FIG. 1A) for performing one or more of the methods described herein (e.g. method 100 of FIG. 1 or portions thereof). System 60 may comprise a processor 62, a memory module 64, an input module 66, and an output module 68. Memory module 64 may store one or more of the data, models and/or representations described herein. Processor 62 may receive (via input module 66) training poses 107 and may store these inputs in memory module 64. Processor 62 may perform training portion 133 of method 100 to develop approximation model 120 and rasterization matrices 127 as described herein, and store this model 120 and matrices 127 in memory module 64. Processor 62 may receive some of computation parameters 113 (via input module 66) or may determine some of computation parameters 113 and may store such data in memory module 64. In some embodiments (by way of non-limiting example, where real-time rendering is not involved), processor 62 may also perform some or all of interpolation/rendering portion 130, in which case processor 62 may receive target facial expressions 503 and generate rendered images 585 (which may be stored in memory module 64). In other embodiments (by way of non-limiting example, where real-time rendering is involved, some of all of interpolation/rendering portion 130 may be performed by a separate processor (e.g. a graphics processing unit (GPU) or the like that is specialized for rendering images).

Method 100 begins at blocks 105 and 110. Block 105 comprises acquiring training data comprising a plurality of various high-resolution 3D facial training poses 107. 3D training poses 107 may be obtained at block 105 in any suitable manner. For example, training poses 107 may be determined by capturing a facial performance of an actor using suitable facial capture studios comprising multiple cameras. The facial capture studio may comprise a light stage setup (e.g. light stages, such as those provided by University of Southern California ICT and Otoy Inc.) or a static multi-view capture setup, for example. These methods of acquiring 3D training poses 107 typically comprise an actor's controlled execution of a number of different facial expressions in various different lighting conditions.

Each training pose 107A from among the plurality of training poses 107 may comprise or be derived from a series of still images in the form of encoded digital data which, together, capture facial geometry and texture information for that pose. The series of still images for each pose 107A may comprise images obtained by facial capture hardware (e.g. cameras) from various angles and under various lighting conditions—e.g. one still image for each camera for each pose 107A. These individual images may be pre-processed and combined to form one or more 3D geometries/3D models (typically a 3D mesh) and one or more high-resolution texture maps.

In some embodiments, training poses 107 obtained through light stage techniques involving an actor are modified by an artist to improve accuracy or to remedy defects in the light stage process. Certain aspects of training poses 107, such as a pose's geometry, may be obtained by a process of manual modelling performed by an artist using 3D modelling software, either in conjunction with or as an alternative to capture techniques. Manual artist modifications may also be made to emulate certain facial features, such as those of a famous person, to be rendered.

Training poses 107, as a group, may preferably comprise a number of different facial expressions which capture various skin deformation patterns in the form of 3D facial geometry sets or models (e.g. a 3D geometry or 3D mesh configuration for each training pose 107A). For example, different facial expressions that might be depicted in training poses 107 include a smiling expression, a frowning expression and an eyebrow raising expression, amongst others. In some embodiments, a taxonomized system of human facial movements is employed in determining the various facial expressions which are part of training poses 107. For example, facial expressions in poses 107 may comprise FACS expressions or other standardized expressions. In some embodiments, block 105 comprises obtaining between 10 to 30 different training poses 107, although fewer training poses 107 or a greater number of training poses 107 could be obtained. According to a specific non-limiting example embodiment, block 105 comprises obtaining data from 20 training poses.

Each pose or expression 107A (from among the plurality of training poses 107) comprises a set of high-resolution 2D textures which reflect the skin's appearance attributes at that particular pose 107A. Each high-resolution 2D texture may be provided in the form of a 2D image of high-resolution pixels (commonly referred to as texels) in a 2D space commonly referred to as a UV space. In some embodiments, there are about 12 types of textures that are captured at each pose 107A, although different numbers of textures could be used. These different textures capture different properties of skin in a manner that can be re-combined and used for rendering through the use of shader software. For example, a shader program may interpret a number of different textures which cumulatively represent the appearance of how a single point on the surface of a face reflects and/or absorbs incoming light. For example, a specular and roughness texture value represents the reflection of the oily layer of skin, a diffuse value reflects the colour of the skin's epidermis and a normal value reflects the bumpiness of the skin. Other texture properties known in the art including, without limitation, occlusion, bent normal, ambient and albedo may be included in the 2D texture sets contained in or otherwise associated with each pose 107A of training poses 107. Scans of the actor's face may be obtained with various detailed texture information, taken under various illumination conditions, for obtaining the different desired textures for each pose 107A.

At block 110, method 100 involves the assessment of a number of computational parameters based on the computational budget. In some applications, the computational budget may be a fixed parameter or a given parameter for method 100. In such applications, the block 110 computational parameters may be received (e.g. as input), hard-coded or otherwise determined based on this fixed or given computational budget. There may be a number of primary considerations in the assessment performed at block 110. It is contemplated that method 100 may be used in real-time rendering to interpolate realistic high-resolution textures (e.g. in applications such as video games or for rendering digital (e.g. CGI) avatars based on a person's face). Accordingly, in embodiments where method 100 is employed in a real-time scenario, one of the primary block 110 considerations is the desired frame rate, measured in frames per second (FPS), of the real-time rendering. In such embodiments, block 110 may comprise determining a desired frame rate for the real-time texture rendering. Generally, for a higher desired frame rate of the rendering, the overall computational budget would be correspondingly higher, as method 100 may be performed an increased number of times within the same time frame or equivalently, the period within which each successive frame is rendered is correspondingly low. Consequently, in some embodiments where the overall computational budget is fixed or given, the computational budget for rendering individual frames may be adjusted as a result of selecting an appropriate frame rate. As illustrative examples, the frame rate determined at block 110 may be 24 FPS, 30 FPS, 48 FPS, 60 FPS, 120 FPS or 240 FPS.

Another block 110 consideration, which may be relevant to some applications of method 100, is the desired weight texture resolution. As will be described in further detail below, embodiments of the present invention involve interpolating high-resolution textures based on a low-resolution weight texture map 575 (also referred to herein, for brevity, as a weight texture map 575). As explained in more detail below, the low-resolution weight texture map is a 2-dimensional array of pixels which span the 3D facial surface topology in UV space and which provides, for each pixel n (where n∈1, 2 . . . . N), a number of weight texture values which may take the form of a weight texture vector rₙ (567) . . . . In addition to the determination of a desired frame rate, block 110 may further comprise determining a resolution to be used for low-resolution weight texture map 575 based on the computational budget. As illustrative examples, weight texture map 575 may comprise a resolution of 32×32, 64×64, 128×128, 256×256, 512×512 and 1024×1024 pixels. Other resolutions are possible. Where a lower weight texture map resolution is used, coarser regions of the rendered faces 585 are determined by corresponding combinations of interpolation weights and the computational cost may be relatively low. Conversely, finer regions of the rendered faces 585 are determined by corresponding combinations of interpolation weights where a higher resolution weight texture map resolution is used and the computational cost may be relatively high.

Additionally, block 110 may comprise making an assessment on the number P of poses 107A from among the set of training poses 107 to employ in interpolating the high-resolution textures of a target facial expression (i.e. a target facial pose to be rendered). As will be described in further detail below, method 100 determines the textures of the target facial expression based on interpolating high-resolution textures corresponding to the P training poses. Accordingly, a higher number P of training poses 107A used in the interpolation computation corresponds to a higher computation cost. For example, the addition of a training pose 107A may quadratically add to the complexity of the blending weights (described further below) used in the real-time texture interpolation computation. However, increasing the number P of training poses that are utilized allows for greater accuracy in conforming the textures of the target facial pose to that of the most representative combination of the set of available training poses 107. The selection of the number P of poses 107A also has an impact on the training process performed at block 120, discussed below, where a greater number P of poses 107A typically requires more time to train the model at block 120.

In some embodiments, determining the computational parameters at block 110 comprises determining how many instructions the shader is able to execute for each rendered frame. This determination may comprise selecting the number P of high-resolution textures that can be interpolated and rendered during the real-time computation given the computational budget. In some embodiments, this involves considering the particular details of the shader software being used.

Block 110 produces an output of computational parameters 113. Computational parameters 113 may comprise, given the computation budget of a particular run-time scenario, a low-resolution weight texture resolution and a number P of training poses 107A to employ for interpolation computations. Optionally, where method 100 is employed as part of a real-time rendering, computational parameters 113 may comprise a desired frame rate and/or some indicia of the number of instructions or operations that can be performed per frame. In some embodiments, the determination of computational parameters at block 110 may be performed by a technician (possibly using the assistance of some computer-based system). The technician may be a shader coder who determines the largest number of texture operations that can be input to the shader (texture reads, interpolations, etc.) based on a desired frame rate. In some embodiments, the determination at block 110 is additionally or alternatively performed by a software algorithm, which is optionally able to receive a set of guiding instructions. Computational parameters 113 may additionally comprise a resolution of high-resolution textures that are uploaded to the GPU. For example, downscaled versions of the high-resolution textures from training poses 107 may be supplied for use in less sophisticated processing hardware.

The selection of a desired frame rate, a resolution for the low-resolution weight texture map 575, and the number P of poses 107A used for interpolation are mutually dependent on one another, taking into account the computational budget. A higher one of any of these parameters typically results in the consumption of a greater amount of the computational budget. For example, if a higher frame rate were desired, then the resolution of the low-resolution weight texture map 575 and the number P of selected training poses 107A would typically have to be correspondingly lower, given finite computational resources. Likewise, if a higher resolution low-resolution weight texture map 575 or the use of a greater number P of training poses 107A were desired, then the other ones of computational parameters 113 would typically have to be corresponding lower, given finite computational resources.

Upon the completion of blocks 105 and 110, method 100 proceeds to block 115 which involves the determination of a neutral-pose mesh and a number of feature graphs 117. The number of feature graphs determined in block 115 may correspond to the number P of selected training poses 107A. As used and explained in more detail herein, a “neutral-pose mesh” is an example of a “feature graph geometry” and is a particular feature graph geometry corresponding to a “neutral pose” selected from among the P selected training poses 107A. The neutral-pose mesh provides a representation of a facial geometry according to which “feature graphs” may be defined. A “feature graph geometry” comprises a low-resolution mesh representation of the facial geometry of a training pose 107A (e.g. a particular one of the P selected training poses 107A) or other pose (e.g. a target facial expression 503 described in more detail below) comprising a number W of vertices (which may be referred to herein as handle vertices) sparsely located around the face with edges (having defined edge-lengths) connecting adjacent vertices. The edges of a feature graph geometry may also be referred to herein as feature edges. A feature graph geometry may also be referred to herein as a low-resolution geometry.

A “feature graph” corresponding to a training pose 107A (e.g. one of the P selected training poses 107A) is a representation of the corresponding training pose 107A which comprises a set of primitive parameters on the feature graph geometry of the corresponding training pose 107A which may be based on characteristics of the corresponding training pose 107A and the neutral-pose mesh. In some embodiments, the primitive parameters comprise “edge parameters” or “edge characteristics”, where each edge parameter may be determined based on the edge length of the feature graph geometry of the corresponding training pose 107A and the edge length of the corresponding edge of the neutral-pose mesh. In some such embodiments, each edge parameter of a feature graph for a training pose comprises an edge strain which comprises a ratio of the edge length of the feature graph geometry of the corresponding training pose 107A to the edge length of the corresponding edge of the neutral-pose mesh. Such edge parameters may provide an indication of whether the edges of a feature graph geometry corresponding to a particular training pose 107A are stretched or compressed when compared to corresponding edges of the neutral-pose mesh.

In some embodiments, each primitive parameter of a feature graph for a training pose comprises a deformation gradient or other derivable parameter(s) which may be based on other additional or alternative characteristics of the corresponding training pose 107A and the neutral-pose mesh. By way of non-limiting example, such other additional or alternative characteristics could include pyramid coordinates (as described, for example, in Sheffer, Alla & Kraevoy, V. (2004). Pyramid coordinates for morphing and deformation. 68-75. 10.1109/TDPVT.2004.1335149, which is hereby incorporated herein by reference), linear rotation-invariant coordinates (as described, for example, in Lipman, Yaron & Sorkine, Olga & Levin, Dαv,id & Cohen-Or, Daniel. (2005). Linear Rotation-Invariant Coordinates for Meshes. ACM Trans. Graph. 24. 479-487. 10.1145/1073204.1073217, which is hereby incorporated herein by reference) and/or the like. The remainder of this specification may describe the primitive parameters of feature graphs as being “edge parameters” or “edge characteristics” without loss of generality that these edge parameters could additionally or alternatively comprise other primitive parameters, which may be based, for example, on triangle parameters, 1-ring neighbor parameters and/or the like. Unless the context specifically dictates otherwise, references herein to edge parameters should be understood to include the possibility that such edge parameters could include additional or alternative primitive parameters.

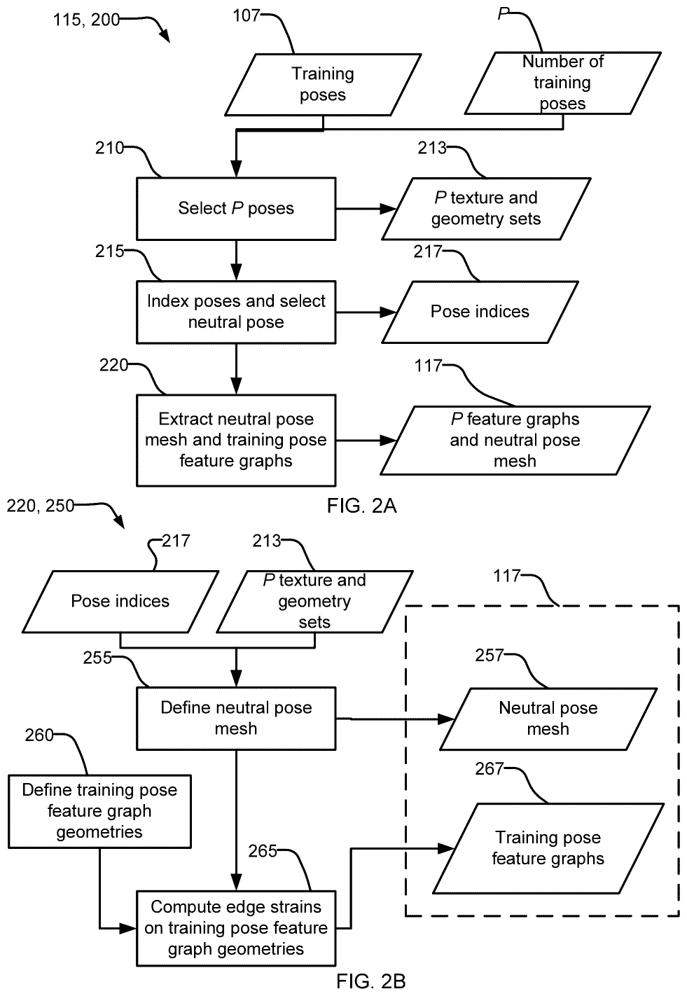

FIG. 2A schematically depicts a method 200 that may be used for determining the feature graphs for the P selected training poses 107A. Method 200 receives as inputs, training poses 107 obtained from block 105 of method 100, and a number P of the training poses 107 to be used. The number P of training poses 107 to be used in method 200 may be provided as part of computational parameters 113.

At block 210, method 200 selects P poses from among the input set of high-resolution facial training poses 107. In currently preferred embodiments, the P poses 107A that are selected represent extreme facial expressions in the sense that the facial expressions of the P selected training poses 107A are significantly different from one another. This may be accomplished in a number of ways, including, but not limited to:
selection by a trained technician relying on their subjective opinion on which training poses 107A constitute the largest or sufficiently large differences from other training poses 107A;
selection aided by computer software which analyzes a cumulative difference value between various combinations of the input training poses 107 and selecting the P poses that have the highest or sufficiently high cumulative difference; and
selection by comparing the conformity of the different input training poses 107 to various standard FACS poses.

In some embodiments, the number of training poses 107A acquired in block 105 of method 100 coincides with the determined number of P poses 107A from an earlier performance of block 110. In other words, training data 107 may be acquired with a view to the specific needs and limitations of the computational environment. As an illustrative example, where the block 110 determination of the desired number of poses is P=6, the number of training poses 107A obtained at block 105 may correspondingly be 6 plus a number of optional buffer poses 107A to account for errors and/or for performing calibrations. This approach may be advantageous where the process of obtaining training poses 107 (e.g. in block 105) is expensive and/or time-consuming.

The selection of P poses at block 210 results in P facial texture and geometry sets 213. The P facial texture and geometry sets 213 come directly from training poses 107 and comprise the various sets of high-resolution textures and the high-resolution facial geometry for each of the P selected poses. In some embodiments, P facial texture and geometry sets 213 may comprise, for each of the P geometries, a high-resolution mesh whose vertex locations define the facial surface geometry and a corresponding plurality of 2D high-resolution facial textures. Method 200 proceeds to block 215, where a neutral pose is selected from among the P block 210 selected poses. The neutral pose may be selected from among the P poses as the pose that is closest to a relaxed expressionless face. In some embodiments, the neutral pose is defined in relation to the FACS standard for a ‘neutral face’. As will be explained below, the feature graph geometry (or low-resolution geometry) corresponding to the block 215 selected neutral pose (or neutral-pose mesh) provides the basis according to which the feature graphs of the P training poses (and their edge parameters) are defined. Also at block 215, each of the P training poses is indexed from 1≤k≤P, where kis the index for a specific pose, resulting in pose indices 217.

Method 200 proceeds to block 220 which comprises extracting the neutral-pose mesh (i.e. the low-resolution feature graph geometry corresponding to the block 215 selected neutral pose) and the feature graphs of the P training poses, resulting in P feature graphs and neutral-pose mesh 117.

FIG. 2B schematically depicts a method 250 that may be used for extracting the P feature graphs and neutral-pose mesh 117 at block 220 of method 200 according to an example embodiment of the invention. Method 250 involves using edge strains as the edge parameters of the P feature graphs (e.g. for relating the edges of the feature graph geometries of each of the P training poses to the edges of the neutral-pose mesh). In some embodiments, as discussed above, the feature graphs determined at block 220 are determined based on other primitive parameters which may be additional to or alternative to edge strains. Examples of such other primitive parameters include, but are not limited to, calculating deformation gradients and pyramid coordinates. In some embodiments, triangle meshes and/or one-ring neighbours of vertices may be used, in addition to or in the alternative to feature edges, to compare the feature graph geometries of the P selected training poses to the feature graph geometry of the neutral pose.

Method 250 receives, as inputs, P high-resolution texture and geometry sets 213 and pose indices 217, determined at blocks 210 and 215 of method 200. At block 255, method 250 defines the neutral-pose mesh 257. As discussed elsewhere herein, neutral-pose mesh 257 is a feature graph geometry (low-resolution mesh) corresponding to the neutral pose selected in block 215. The determination of neutral pose mesh 257 at block 255 first comprises the definition of a plurality W of sparsely located handle vertices H_{w} where w∈[1, 2, . . . W] corresponding to a subset of the V vertices of the high-resolution mesh topology of training poses 107—i.e. there are W handle vertices selected from among the Vhigh-resolution vertices of the mesh topology of training poses 107 and each handle vertex H_{w} corresponds to one of the V high-resolution vertices. These sparsely located vertices H_{w} may be assigned a numerical index from 1≤w≤W. The edges connecting adjacent pairs of these low-resolution handle vertices H_{w} approximately correspond to the shape of the face and may accordingly represent various facial features and/or expressions. The edges connecting adjacent pairs of these handle vertices H_{w} (which may be referred to as feature edges) may be assigned corresponding edge lengths based on the geometries of the handle vertices H_{w}.

There are a number of possible ways in which the neutral-pose mesh 257 may be determined at block 255. For example, the neutral pose (selected from among the P selected training poses 107A in block 215) may be segmented into a rectangular graph of evenly distributed handle vertices H_{w} in the UV space of the original high-resolution neutral pose geometry selected in block 215. This approach has the advantage of being able to be applied automatically and with little to no computation or manipulation, as the rectangular graph may be indiscriminately applied to a face. In other embodiments, the vertices H_{w} used to determine neutral-pose mesh 257 are defined at block 255 with reference to fiducial points (vertices) located on the face for best capturing how edges of the face stretch and compress. Such fiducial points (vertices) are typically located in regions around the nose, eyes, mouth, etc.

In some embodiments, the determination of the neutral-pose mesh 257 may employ an automatic facial detection module and/or a manual selection procedure. The determination using fiducial points (vertices) has the advantage of adapting vertices and edges based on an anatomical understanding of different facial elements. As an illustrative example, the nose is known to not deform significant amounts across different facial expressions. Accordingly, a lower number of fiducial points (vertices) may be assigned to the nose area. Conversely, the forehead experiences a wide range of variation across different facial expressions and may be assigned a higher number of fiducial points (vertices) and edges connecting those points (vertices) in some embodiments.

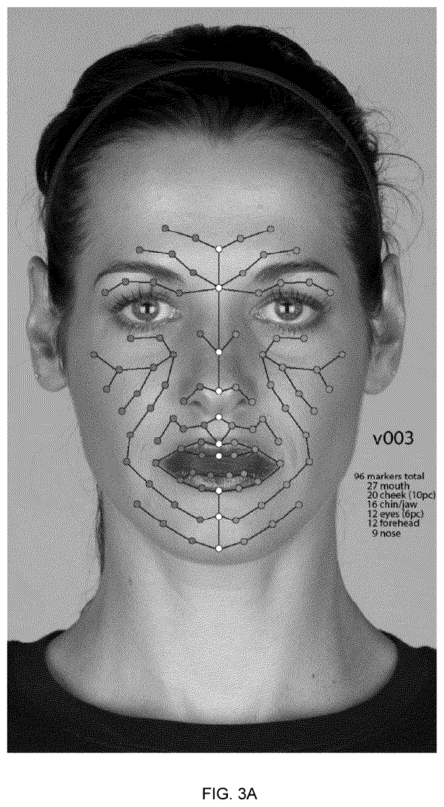

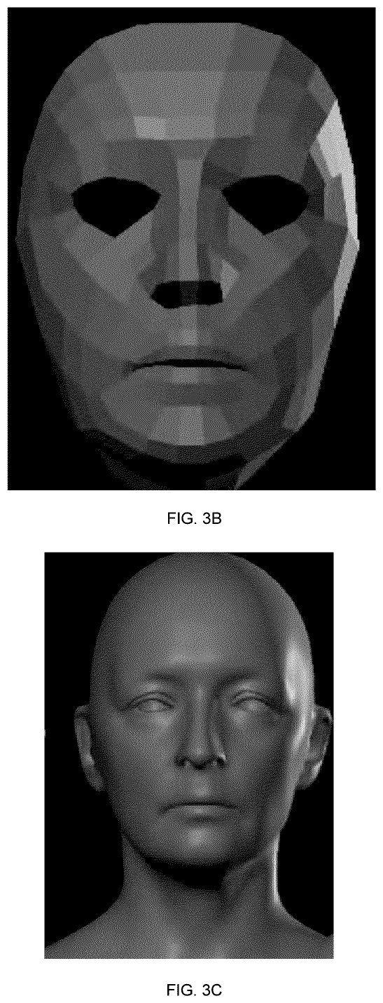

FIG. 3A shows an example marker layout for use in capturing a digital representation of an actor's face. As shown, a plurality of markers are distributed at various locations on the actor's face, wherein the distribution may be based on any of the methods described herein. The locations of markers shown in FIG. 3A may be used for the locations of fiducial points (vertices) and corresponding handle vertices H_{w} of a low-resolution (i.e. feature graph) geometry. FIG. 3A also shows a number of edges connected between adjacent vertices. The number of edges shown in FIG. 3A is relatively low to simplify the appearance of the FIG. 3A image. In practice, additional edges may be provided between other adjacent vertices (e.g. in accordance with some suitable geometrical definition of adjacency). FIG. 3B shows an example representation of a low-resolution (i.e. feature graph) geometry comprising a full complement of edges that may be obtained from connecting the sparsely located markers/vertices H_{w} of a captured facial expression (such as that in FIG. 3A) using edges. FIG. 3C shows an example representation of a high-resolution facial expression corresponding to FIGS. 3A and 3B, which may form part of the P facial texture and geometry sets 213.

In some embodiments, the vertices H_{w} of the neutral-pose mesh 257 are defined as part of the data acquisition process at block 105 of method 100. For example, the vertices H_{w} of the neutral-pose mesh 257 may be defined by and correspond to motion capture markers on an actor's face during the performance of block 105 (where the P training poses 107A are captured). In some embodiments, the definition of the neutral-pose mesh 257 at block 255 comprises using the motion capture markers optionally supplemented by virtually defined vertices located therebetween. In some embodiments, the resolution of vertices H_{w}, and thus, the precision of the facial features that are tracked, may be set as part of the determination of computational parameters at block 110.

The resolution of vertices H_{w} for low-resolution meshes described herein is preferably selected to be able to capture sufficient information to describe the face's current pose in any given region. In some embodiments, it may be preferable to have a relatively high concentration of vertices H_{w} in locations where textures and/or geometry are expected to have a relatively high degree of local variation, such as at the lips. This allows the high-resolution weight texture interpolations to distinguish between finer skin deformations between the P training poses 107A. In contrast, in regions where the textures are expected to be relatively consistent, such as at the cheeks, relatively few vertices H_{w} may be provided to represent those regions. As a non-limiting illustrative example embodiment, the number of vertices H_{w} defining the geometry of a low-resolution mesh may be in the range of about 50-300. According to a more specific example, 100-200 vertices H_{w} define the geometry of a low-resolution mesh.

Returning to method 250 of FIG. 2B, at block 260, the feature graph geometries (also referred to as low-resolution meshes) of the P training poses are defined. The training pose feature graph geometries are defined in block 260 using the same vertices H_{w} as those used in the block 255 definition of neutral-pose mesh 257. This allows for a correspondence between the low-resolution mesh representations of each of the P training poses 107A to be made with respect to neutral-pose mesh 257 (i.e. these representations have the same topology), so that characteristics (e.g. edge lengths and/or other edge characteristics and/or other primitive parameters) of the low-resolution meshes (feature graph geometries) corresponding to each of the P training poses 107A may be easily compared to corresponding characteristics of neutral-pose mesh 257 (i.e. the feature graph geometry of the neutral pose selected in block 215). Accordingly, the vertex indices w∈[1, 2, . . . W] of the low-resolution meshes (feature graph geometries) of the P training poses correspond to those in neutral-pose mesh 257.

After defining the low-resolution meshes (feature graph geometries) for the P training poses 107A at blocks 255 and 260, method 250 proceeds to block 265, where feature graphs 267 are computed for each of the P training poses 107A based on characteristics of the block 260 low-resolution meshes of each of the P training poses 107A and corresponding characteristics neutral-pose mesh 257. As discussed, each of the block 260 low-resolution meshes (feature graph geometries) approximately follow the contour of a corresponding training pose 107A and can be related to neutral-pose mesh 257 based on corresponding edge characteristics (e.g. the lengths of corresponding edges) to determine feature graphs 267. The edge lengths in the block 260 low-resolution mesh representations (feature graph geometries) of the P training poses may be used for relating the skin strain of a training pose relative to the neutral pose by comparison (e.g. taking an edge length ratio) to corresponding edges of neutral-pose mesh 257 to thereby determined feature graphs 267.

The skin strain of F feature edges in each of the block 260 low-resolution meshes (feature graph geometries) for the P training poses 107A may be expressed as an F-dimensional feature vector ƒ=[ƒ₁ . . . ƒ_{F}]^{T} where ƒᵢ is the relative stretch (also referred to herein as strain) of the i^{th} feature edge and the vector ƒ may be referred to herein as a feature graph. In some embodiments, ƒᵢ is defined as follows:

$${f}_{i} = ( ‖ {p}_{i , 1} - {p}_{i , 2} ‖ - {l}_{i} ) / {l}_{i} \qquad ( 3 )$$

where p_{i,1} and p_{i,2} are the position vectors corresponding to the endpoints of ƒᵢ (e.g. a pair of corresponding vertices H_{w} in the corresponding feature graph geometry), and lᵢ is the rest length of the corresponding i^{th} edge of neutral-pose mesh 257 (e.g. the length between the same two vertices H_{w} in the neutral-pose mesh 257). According to the notation in equation (1), a feature vector value ƒᵢ having a negative value represents a compression relative to the neutral-pose mesh 257 and a feature vector value ƒᵢ having a positive value represents a stretching relative to the neutral-pose mesh 257. The performance of block 265 yields training pose feature graphs 267 for each of the P training poses 107A.

In some embodiments, other additional or alternative primitive parameters of the block 260 low-resolution meshes (feature graph geometries) of the P training poses 107A and corresponding parameters of neutral-pose mesh 257 may be used to determine feature graphs 267. Non-limiting examples of such additional or alternative primitive parameters include deformation gradients and pyramid coordinates.

At its conclusion, method 250 returns neutral-pose mesh 257 and P feature graphs 267 corresponding to the P selected poses 107A. Together, neutral-pose mesh 257 and the P feature graphs 267 shown in FIG. 2B represent P feature graphs and neutral-pose mesh 117 shown in FIGS. 1 and 2A.

Returning to method 100 of FIG. 1, method 100 proceeds to blocks 120 and 125, where an approximation model 123 is trained and a rasterization computation is performed to determine rasterization matrices 127, respectively. According to a currently preferred embodiment, training the approximation model 123 at block 120 comprises defining a set of radial basis functions (RBFs) (e.g. one per vertex) through which training data can be interpolated and be fit to a model. Performance of block 120 results in an approximation model 123, for example, a WPSD model 340 described below, which allows the determination of a correspondence between a target facial expression (target pose) and the plurality of P training poses 107A.

Bickel et al. in Pose-Space Animation and Transfer of Facial Details, ACM SIGGRAPH Symposium on Computer Animation, January 2008, which is hereby incorporated herein by reference, disclose a technique known as weighted pose-space deformation (WPSD) for modelling a relationship between localized skin strain and a corresponding vertex displacement. In training a WPSD model, Bickel discloses employing a fine-scale detail correction d relative to a warped representation of the neutral pose for each training pose. The correction d comprises a vector of size 3V, where there is a displacement amount for each Cartesian coordinate (x, y, z) for each high-resolution vertex v relative to the warped representation of the neutral pose and V and v (in the context of the block 120 training of approximation model 123) would respectively represent the total number V and an index for the individual ones v∈[1, 2, . . . V] of high-resolution vertices of the selected P training poses 107A. The corrective displacements d disclosed by Bickel are then represented in a collection of RBFs trained on the P training poses 107A.

Some embodiments of the present invention leverage techniques similar to those disclosed by Bickel et al. with a difference that instead of applying WPSD in the context of computing vertex displacements, the WPSD techniques used in block 120 instead determine per-high-resolution-vertex texture interpolation weights. In other words, the present techniques disclose determining per-high-resolution-vertex texture interpolation weights representing similarity of a target facial expression (target pose) 503 to the P training poses 107A rather than an absolute displacement. Such interpolation weights can be used for interpolating high-resolution textures in subsequent steps, as discussed later herein.

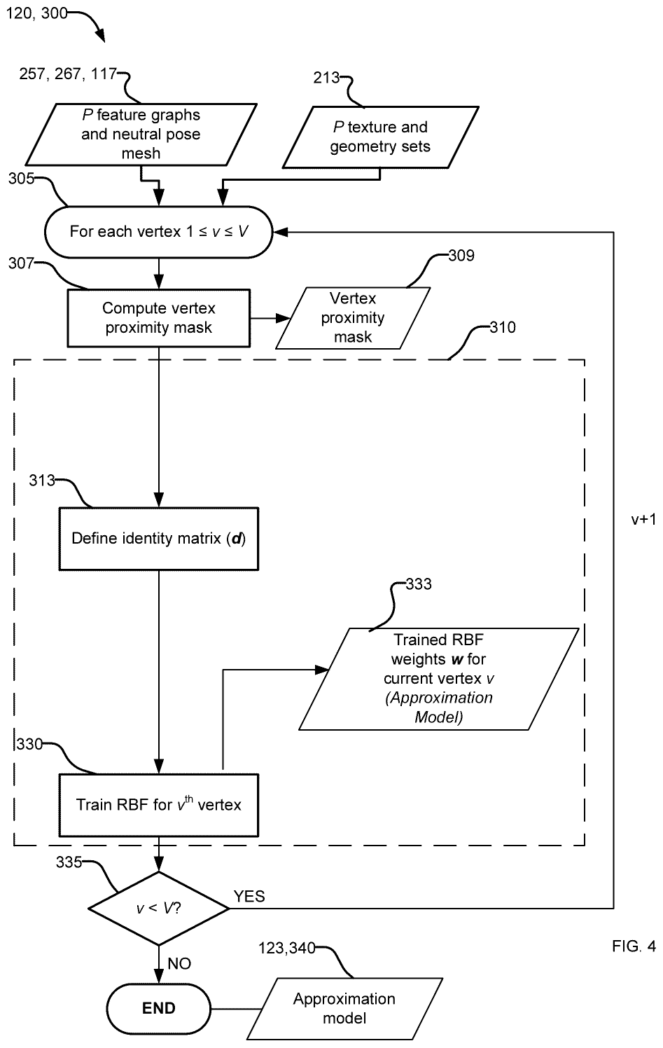

FIG. 4 schematically depicts an example training method 300 that may be used to implement block 120 (FIG. 1) to develop and train an approximation model 123 according to a particular embodiment. In other embodiments, other suitable techniques for solving problems known as “sparse data interpolation” problems may be used in the performance of block 120 to implement a training technique for generating approximation model 123. Non-limiting examples of such methods include least-squares polynomial regression, k-nearest neighbors interpolation, weighted interpolation methods and/or the like. In the illustrated embodiment of FIG. 4, method 300 depicts a number of steps for obtaining an approximation model 340. Approximation model 340 represents one example of an approximation model 123 that may be trained in block 120 of FIG. 1.

Method 300 receives, as input, P texture and geometry sets 213 (see FIG. 2A) and P feature graphs 267 and neutral-pose mesh 257 (together, P feature graphs and neutral-pose mesh 117—see FIG. 1 and FIG. 2B), obtained through the performance of method 200 (FIG. 2A) and possibly method 250 (FIG. 2B). Method 300 comprises a loop (effected by blocks 305 and 335) which involves performing a number of steps for each high-resolution vertex v (indexed from 1≤v≤V). At block 305, an initial vertex v₁ is selected from amongst the complete set of high-resolution vertices V (which may be defined in each of the P input geometry sets 213) for which the approximation model 340 is to be trained. Similar to the handle vertices H_{w} used to define the P feature graphs 267, each high-resolution vertex v corresponds to the same high-resolution vertex across the different P high-resolution training poses 107A (high-resolution training poses 107A have the same topology) and may be indexed from 1≤v≤V. In the illustrated embodiment of FIG. 4, the interpolation problem may be solved independently on each high-resolution vertex v, with approximation model 340 representing the collection of trained RBFs, one trained RBF for each high-resolution vertex v for a total of VRBFs. That is, the solution for a vertex located on the cheek is obtained independently of the solution for a vertex located on the nose, for example. In other embodiments, the loop effected by blocks 305 and 335 is performed only for certain high-resolution vertices v (i.e. a subset of the total number of high-resolution vertices V which may correspond to a union of the vertices determined in block 415), as described further herein.

At block 307, a vertex proximity mask 309 is computed using the high-resolution neutral pose (which is one of the P geometry sets 213) and the neutral pose mesh 257. The vertex proximity mask 309 is used for assigning relative weights based on the proximity of a high-resolution vertex v to different feature edges. According to an example embodiment, the calculation of the weight α_{v,i} of the i^{th} feature edge at the v^{th} vertex is computed at block 307 and may take the form:

$${α}_{v , i} = \frac{{\overline{α}}_{v , i}}{{\sum }_{i} {\overline{α}}_{v , i}} , with {\overline{α}}_{v , i} = {e}^{- β ( {L}_{v , i} - {l}_{i} )} \qquad ( 4 )$$

where: lᵢ has the same meaning as discussed above in relation to equation (1) (i.e. the rest length of the i^{th} low-resolution feature edge of neutral-pose mesh 257), and L_{v,i} is the sum of the neutral pose distances from high-resolution vertex v to the locations of the endpoints of the i^{th} low-resolution feature edge of the neutral-pose mesh 257. These distances may be Euclidean distances or geodesic distances, for example. In some embodiments, α_{v,i} is 1 for the edges surrounding the current vertex v and decaying everywhere else. The parameter β of equation (2) is a configurable scalar parameter that can be used to adjust the rate of decay.

In some embodiments, following the determination of weights α_{v,i}, block 307 may further comprise multiplying the edge strain value ƒᵢ for each feature edge (see equation (1)) of the P training poses 107A by the proximity weights α_{v,i} to obtain vertex proximity mask 309 for the current vertex v. In some embodiments, for a particular high-resolution vertex v, low-resolution feature edges having weights α_{v,i} less than some suitable and, optionally user-configurable, threshold (e.g. 0.0025) are omitted from consideration in subsequent steps of method 300. According to a specific example embodiment, a vertex v may be influenced by at most some suitable, optionally user-configurable, threshold number (e.g. 16) low-resolution feature edges in the performance of method 300. Limiting the number of feature edges that are considered may advantageously decrease the computational complexity in the performance of method 300 by requiring consideration of fewer low-resolution feature edges per high-resolution vertex v and by considering strains with the most influence on that particular vertex v. In other embodiments, all low-resolution feature edges are considered in the computations at each high-resolution vertex v, regardless of their proximity to the high-resolution vertex v. The execution of block 307 over the set of high-resolution vertices V results in vertex proximity mask 309 containing a weight α_{v,i}, for each feature edge ƒᵢ for each high-resolution vertex v.

Following the completion of block 307, method 300 proceeds to sub-process 310 where a radial basis function representing the interpolation problem for the current vertex v is trained. Performance of sub-process 310 may involve using an equation of the general form:

$$d = w ϕ \qquad ( 3 )$$

where: matrix d has the dimension P×P and has columns which define the target blending weights to be learned by the RBF during the block 310 training, matrix w has the dimension P×P and represents the unknown variables of the RBF weights for which training sub-process 310 aims to solve, and ϕ is a P×P dimensioned RBF kernel representing a distance or any other suitable measure of similarity of the particular vertex v in a training pose 107A to all of the other selected training poses 107A based on the relative strain of feature edges surrounding the particular vertex v. For example, ϕ may represent a similarity measured with L2 norm of the feature graph around a particular vertex v in in each one of the P training poses 107A to all of the P training poses 107A, which describes how similar the strains of the surrounding feature edges are to the P training poses.

Block 313 involves creating a P×P dimensioned identity matrix d for which all of the values are zero except for at d_{1,1}, d_{2,2} . . . d_{P,P}, where the value is 1. This identity matrix d represents the interpolation (blending) weights to be learned during the block 310 training, wherein a set of RBF weights w is desired such that the computation of the right-hand side of equation (3) achieves a similarity ratio of 1 for each of the P training poses relative to itself and a similarity ratio of 0 to all other poses.

In some embodiments, the block 310 RBF training technique comprises determining distances on a weighted per-vertex manner wherein the distance metric (i.e. ϕ in equation (3) for the current vertex v, which may be referred to as ϕᵥ) takes the form of a distance-weighted RBF, where the value of ϕᵥ at the k^{th} column and the l^{th} row (ϕ_{v,k,l}) may be expressed as:

$${ϕ}_{v , k , l} = γ ( {\sum }_{i = 1}^{F} {α}_{v , i} {( {( {f}_{k , i} - {f}_{l , i} )}^{{}_{2}} )}^{{}_{{}_{{}_{1 / 2}}}} \qquad ( 4 )$$

where: γ is an RBF kernel function (e.g. in some embodiments the biharmonic RBF kernel); ƒ_{k,i} is the strain (the feature graph value determined according to equation (1)) of the i^{th} feature edge in the k^{th} training pose, ƒ_{l,i} is the strain (the feature graph value determined according to equation (1)) of the i^{th} feature edge of the l^{th} training pose, and α_{v,i} is the weight assigned to i^{th} feature edge based on its proximity to the high-resolution vertex of interest v, obtained at block 307 and contained in proximity mask 309 through equation (2). The use of a proximity mask 309 exploits the fact that the relative stretch of feature edges ƒ₁ . . . ƒ_{F} measure properties of varying proximity to a high-resolution vertex of interest v. Accordingly, the use of a distance-weighted RBF may effectively capture the effect of decaying influences of feature edges that are distant from vertex v, while allowing feature edges most proximate to a high-resolution vertex v to have a higher degree of influence. As discussed above in relation to block 307, a number of options are available in the consideration of how weights α_{v,i} and feature edges are employed in method 300.

Equation (3) represents a system of linear equations which underlie a typical RBF and which can be solved by matrix inversion in the form:

$$w = d {ϕ}^{- 1} \qquad ( 6 )$$

At block 330, equation (6) is computed to obtain a P×P weight matrix w which represents the trained RBF weights 333 for the current vertex v, so that inferences can be performed using the matrix w (e.g. through a dot-product as explained in more detail below). The matrix w (trained RBF weights 333) allows for a target pose (target facial expression 503 described in more detail below) to be expressed as a function of its similarity to the P training poses at the particular vertex v.

Following the completion of block 330 and sub-process 310, method 300 proceeds to decision block 335 which evaluates if there are remaining high-resolution vertices v for which RBF weights 333 (matrix w) have not yet been computed. If the inquiry at block 335 is positive, method 300 performs sub-process 310 for a subsequent vertex v according to the steps described above. If the inquiry at block 335 is negative, then method 300 ends. Performance of method 300 results in an approximation model 123, 340 which comprises a set of RBF weights 333 (a matrix w) for each high-resolution vertex v. Approximation model 123, 340 may comprise a tensor having a dimension of [V, P, P]—i.e. a P×P weight matrix w (RBF weights 333) for each vertex v∈{1,2,3 . . . V}. For each vertex v∈{1,2,3 . . . V}, approximation model 123, 340 allows for a target pose to be expressed as a function of its similarity to the P training poses at the vertex v.

Although method 300 (FIG. 4) is discussed in the context of performing block 120 (FIG. 1) to determine an approximation model 123, it will be appreciated that other additional or alternative suitable optimizations or interpolation methods may be applied at block 120 or method 300 to determine similarity weights from a sparse set of samples. For example, where there is a large number of high-resolution vertices and/or a large number of training poses, further approximation or optimization techniques may be performed, such as k-means clustering, Lloyd's algorithm, fitting the multiple training poses in a least-squares manner, and/or the like. In some embodiments, such optimizations (or parts of such optimizations) may optionally be performed as a pre-processing step, prior to the performance of method 300.

The use of radial basis functions (as is the case in method 300) in conjunction with “sparse interpolation problems” is most suitable for sparse interpolation problems where there are a relatively small number of training samples to interpolate. According to current computational capabilities, the sparse interpolation of method 300 (using radial basis functions) may be appropriate for interpolating up to a number of the order of about P=20 training poses. In some embodiments, where the number P of training poses exceeds 20 or where computational resources are limited, a different form of machine learning, such as the use of neural networks, may be appropriate to address this sparse interpolation problem.

Returning to method 100 (FIG. 1), a rasterization computation is performed at block 125. As discussed briefly above, method 100 comprises interpolating high-resolution textures based on a low-resolution weight texture map 575. Performance of block 125 results in a rasterization matrix 127, which comprises a mapping which provides, for each low-resolution pixel n (n∈1, 2 . . . . N) in weight texture map 575, which high-resolution vertice(s) v and corresponding barycentric coordinates should be used to convert the per-high-resolution-vertex approximation model 123 into a per-low-resolution-pixel weight textures rₙ (567). As discussed above, the resolution of low-resolution weight texture map 575 may be provided by computational parameters 113, determined at block 110.

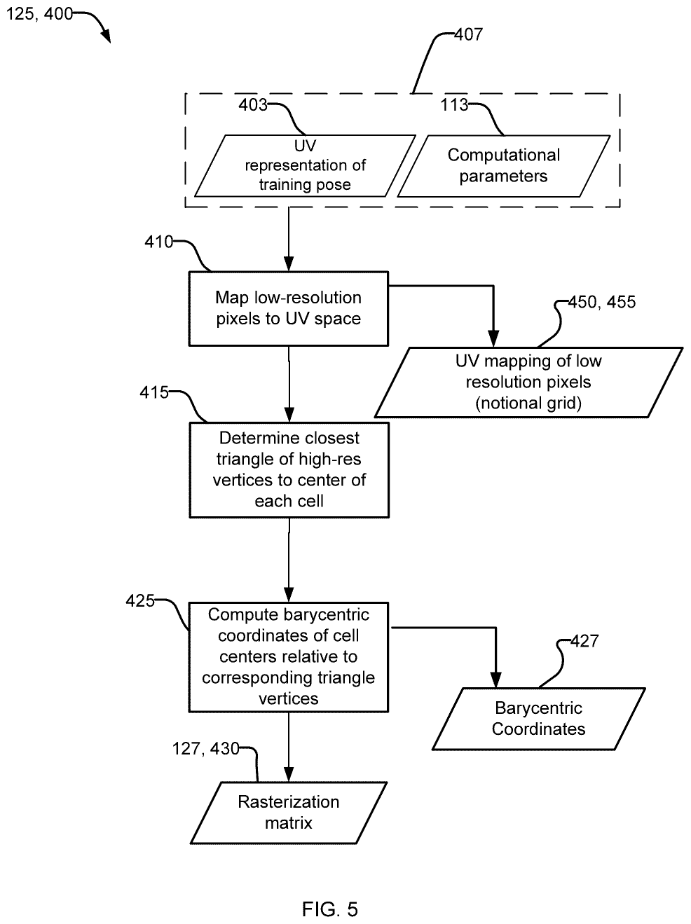

FIG. 5 schematically depicts a method 400 that may be used for the rasterization computation at block 125 of method 100 according to a particular embodiment. The rasterization computation of method 400 depicts a number of steps to obtain rasterization matrix 430, which is the same as the rasterization matrix 127 output from block 125 of method 100 (FIG. 1). Method 400 is supplied with a number of inputs 407. In the illustrated embodiment, inputs 407 comprise a UV representation 403 for the topology of high-resolution training poses 107 and computational parameters 113. UV representation 403 comprises an “unwrapped” 2D depiction of the topology of high-resolution training poses 107. At block 410, method 400 comprises mapping the pixels of low-resolution texture map 575 to UV space to obtain UV mapping 450. Block 410 may be conceptually considered to involve creating a notional grid 455 of cells in UV space. The dimensions of the notional UV-space cells 460 in the block 410 grid 455 correspond to the resolution of the low-resolution weight texture map 575 (which may be part of computation parameters 113 determined in block 110) and the UV coordinates of the pixels in low-resolution weight texture map 575 map to the centers of the cells 460 of the block 410 grid 455. Block 410 may be understood as computing normalized UV coordinates for the pixels in low-resolution weight texture map 575.

The UV coordinate system (or UV space) comprises normalized coordinates ranging from 0 to 1 in a pair or orthogonal directions U and V (i.e. [0,0] to [1,1]). In general, mapping 3D objects such as a face (typically represented by 3D-meshes) into the 2D UV space is a well-known technique used in the field of computer graphics for texture mapping. Each set of 2D coordinates in the UV domain (UV coordinates) uniquely identifies a location in the 3D surface of the object (face). Also, the input textures associated with training poses 107 (e.g. the P texture sets 213) have a unique mapping from texture pixel coordinates (texels) to corresponding UV coordinates. As discussed herein, textures can represent different colours or different surface attributes desirable for rendering realistic faces.

Each cell in the block 410 notional grid 455 of cells may have a constant step size. According to an exemplary embodiment, a particular cell located at particular row and column indices (in the block 410 notional grid 455) has coordinates of column index-# of columns and row index-# of rows in the U and V dimensions, respectively. As discussed above, the resolution of notional grid 455 matches the resolution of weight texture map 575, such that the pixels of weight texture map 575 map to the centers 470 of corresponding cells 460 of notional grid 455. The representation of a 3D facial mesh in UV space may be desirable because graphics engines are typically configured for processing texture data received in the form of texture data mapped to UV space. In other embodiments, the technique of projection mapping may additionally or alternatively be employed at block 410. Other texture mapping systems other than the above-described UV mapping are possible in practicing the various embodiments of the current invention. Another suitable example technique is the Ptex™ system developed by Walt Disney Animation Studios.

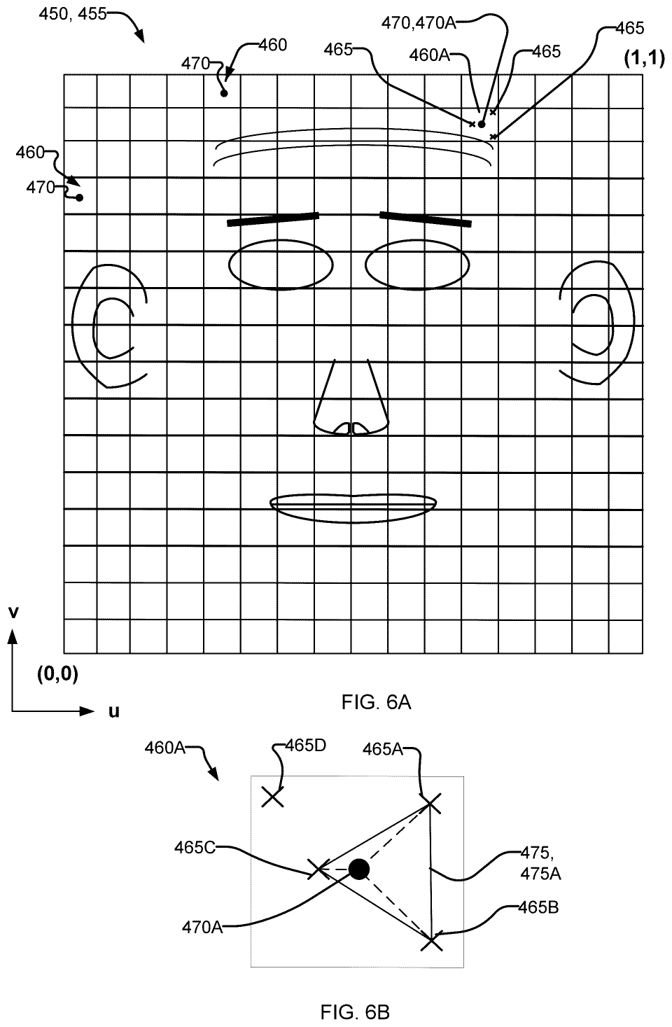

FIG. 6A depicts an illustrative example of a UV coordinate system ranging from (0,0) to (1,1) and a notional low-resolution grid 455 overlaid on the UV coordinate system. Notional low-resolution grid 455 comprises a grid size (i.e. resolution) corresponding to that of low-resolution weight texture map 575 determined in block 110 (FIG. 1), such that UV mapping 450 of the pixels of low-resolution weight texture map 575 map to the centers 470 of the cells 460 of notional grid 455. FIG. 6A also schematically depicts the 3D topology of the mesh associated with input poses 107. The FIG. 6A illustrative example shows a notional low-resolution grid 455 of 16×16 cells (corresponding to the low-resolution weight texture map 575 resolution determined in block 110 (FIG. 1)) in UV space, though it will be appreciated that this resolution is merely illustrative and that block 410 UV mappings 450 (notional grids 455) having other low-resolution weigh texture resolutions are possible. The UV coordinates of a number of exemplary high-resolution vertices 465 (corresponding to the vertices in the topology of input training poses 107) are also shown explicitly in FIG. 6A, it being understood that there may be many more of such vertices.

Returning to FIG. 5, method 400 proceeds to block 415. Block 415 involves identifying the center 470 of each cell 460 of the block 410 notional grid 455 of cells (which corresponds to the UV-space coordinates of the pixels of weight texture map 575) and then, for each UV cell 460 (each pixel of weight texture map 575), determining the high-resolution vertices 465 amongst the set of high-resolution vertices V which form the closest triangle (or other polygon) 475 surrounding the center 470 of the cell 460. An illustrative example of such a block 415 determination is shown in FIG. 6A. In the illustrated example, as the UV coordinate system comprises the range [0,0] to [1,1], the locations of the centers 470 of UV cells 460 (which correspond to the UV-space coordinates of the pixels of weight texture map 575) may be represented as floating point numbers and the selected high-resolution vertices 465 that form the closest triangle may be identified by their vertex indices and by corresponding floating point UV coordinates. In some embodiments, a number of vertices 465 may be selected in block 415, for each UV cell 460 (each pixel of weight texture map 575), which form a polygonal shape other than a triangle.

In the illustrated FIG. 6A example, example UV cell 460A is the 12^{th} cell in the U direction and the 15^{th} cell in the V direction of notional grid 455, depicting a region around the forehead of face. UV cell 460A has a center 470A. FIG. 6B shows a schematic detailed view of cell 460A, including examples of the three closest vertices 465A, 465B and 465C forming a triangle 475A surrounding center 470A. The indices of the three vertices 465A, 465B and 465C are identified and recorded at block 415 as the vertices 465 forming the closest triangle 475A around the center 470A of UV cell 460A (or to the corresponding pixel of weight texture map 575). In the illustrated FIG. 6B example, vertex 465D, while located in UV cell 460A, does not form one of the closest vertices of the triangle 475A surrounding center 470A, and is thus not recorded at block 415 as corresponding to UV cell 460A in the rasterization computation of method 400.

The block 415 process is performed for each of the UV cells 460 in the block 410 notional grid 455. In the FIG. 6A example, this process is performed for 256 different UV cells 460 present in the 16×16 notional grid 455 of UV cells. In embodiments where the number of high-resolution vertices V defining the geometry of training poses 107A is high, there may be a number of vertices which are not considered when performing method 400 (such as vertex 465D in the FIG. 6B example). Conversely, in embodiments where the number of vertices V defining the geometry of training poses 107A is low, it is possible that a single high-resolution vertex 465 may be part of the closest triangle around the centers of two or more separate UV cells 460 (may correspond to two or more pixels of weight texture map 575). As discussed in more detail below, such a vertex 465 corresponding to multiple UV cells 460 (multiple pixels of weight texture map 575) may have different barycentric coordinates for each UV cell 460 (different Barycentric coordinates for each corresponding pixel of weight texture map 575).

Following the identification of vertices 465 corresponding to the centers 470 of UV cells 460 (i.e. corresponding to pixels of weight texture map 575) at block 415, method 400 (FIG. 5) proceeds to block 425, which involves determining, for each UV cell 460, the barycentric coordinates 427 of the corresponding UV-cell center 470 (of the corresponding pixel of weight texture map 575) relative to the closest triangle vertices 465 (as identified at block 415). The barycentric coordinates 427 determined at block 425 comprise a parameterization of UV cells 460 (more particularly, the centers 470 of UV cells 460 or the pixels of weight texture map 575) relative to the high-resolution pixels identified in block 415. For each UV cell 460 (each pixel of weight texture map 575), block 425 may involve determining three barycentric coordinates λ₁, λ₂ and λ₃, which sum to unity and which describe the location of the center 470 of UV cell 460 or the pixel of weight texture map 575 relative to the locations of the high-resolution vertices 465 identified (in block 415) as corresponding to the UV cell 465 or to the corresponding pixel of weight texture map 575. FIG. 6B illustrates an example, where UV cell 460A may have barycentric coordinates 427 of (0.2, 0.2, 0.6) which describe the relationship between center 470A of UV cell 460A relative to vertices 465A, 465B and 465C that form triangle 475A.

Rasterization matrix 430 (which forms the output of method 400 (FIG. 5)) may comprise barycentric coordinates 427 (determined in block 425) for all UV cells 460 of notional grid 455 (or equivalently for all pixels of weight texture map 575) together with corresponding vertex indices of the corresponding triangles and indices of UV cells 460 (or indices of pixels of weight texture map 575). The barycentric coordinates portion of rasterization matrix 430 may comprise a tensor having a dimension of [W, H, 3], where W and Hare the number of cells 460 in the U and V dimensions of the block 410 notional grid 455 (which may correspond, for example, to the resolution of the low-resolution weight texture map 575 determined in block 110 and contained in computation parameters 113) and 3 is the number of Barycentric coordinates.

It will be appreciated that a number of modifications, additions and/or alternatives are available in performing the rasterization computation at block 125 and method 400. Example additional or alternative embodiments include:
defining high-resolution vertices corresponding exactly to UV coordinates of the pixels of weight texture map 575 (i.e. corresponding to the centers 470 of the cells 460 of notional grid 455)—instead of identifying triangle (or other polygon) vertices and computing barycentric coordinates);
instead of computing the barycentric coordinates of the high-resolution vertices forming a triangle (or other polygon) surrounding the UV coordinates of pixel of weight texture map 575 (i.e. surrounding the center 470 of a cell 460 of the notional grid 455), the closest high-resolution vertex to the UV coordinates of the pixel of weight texture map 575 (i.e. the closet vertex to the center 470 of the cell 460) is simply chosen, and the WPSD weights (w) for the training poses 107 at that single high-resolution vertex are used for other aspects of method 100;
using some technique other than barycentric coordinates to obtain a relationship between the high-resolution vertices 465 and the centers 470 of UV cells 460 (i.e. between high-resolution vertices 465 and the UV coordinates of the pixels of weight texture map 575). For example, parameters analogous to barycentric coordinates may be determined for other polygonal shapes.

Returning to method 100 (FIG. 1), after having obtained approximation model 123 at block 120 and rasterization matrix 127 at block 125, method 100 proceeds to block 130, which involves rendering target facial expressions 503 to obtain rendered facial images 585, wherein such block 130 rendering comprises applying (e.g. interpolating) high-resolution textures from the P training poses 107A to a target facial expressions (target poses) 503. Target poses 503 may represent frames of an animation. Prior to block 130 (e.g. in the training portion of method 100 identified by dashed line 133), method 100 comprises steps that may be carried out as part of a series of pre-processing or offline steps. Some embodiments of this invention comprise a number of process steps at block 130 that may be carried out in a real-time computational environment—i.e. block 130 may optionally be performed while digitally rendering target facial expressions (target poses) 503 as successive rendered frames 585 in an animation (e.g. within the frame rate of the corresponding animation) to provide such renderings 585 with highly detailed and animated textures. In a non-limiting example embodiment, block 130 is performed for rendering real-time digital 3D computer graphics (CG) avatars (also known as CG characters). Such CG avatars can have applications in virtual reality, video games and/or the like, for example. In other embodiments, block 130 may be performed in an offline computation environment. A non-limiting example of where an offline performance of block 130 may be used is for rendering CG characters in a feature film project.

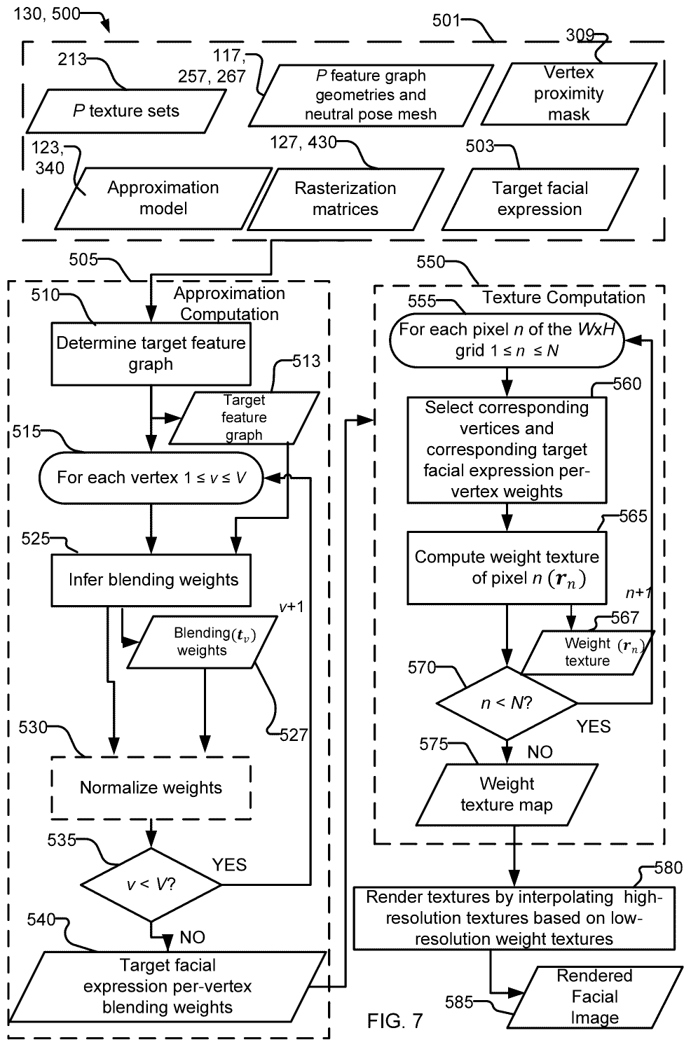

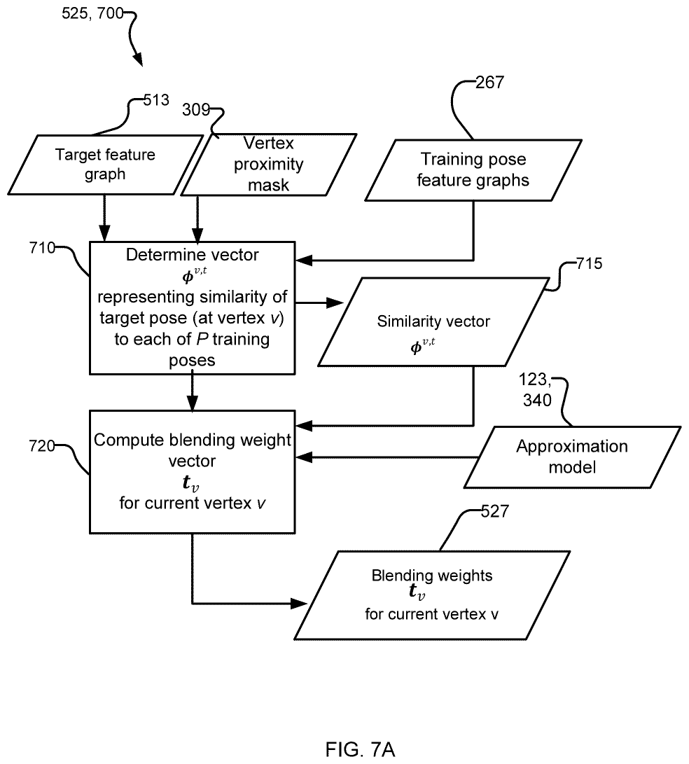

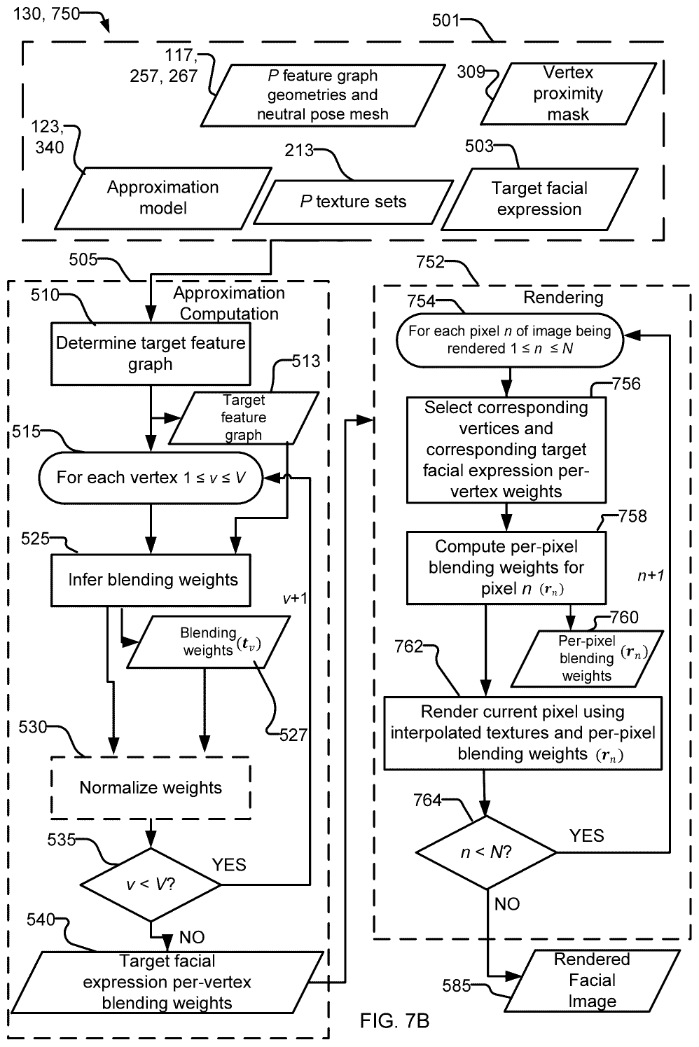

FIG. 7 schematically depicts a method 500 that may be used for animation of high-resolution textures based on facial expressions, through dynamic interpolation, to apply high-resolution textures to target facial expressions (target poses) 503 and to render target facial expressions 503 into rendered facial images 585 in block 130 of method 100. Method 500 is supplied with a number of inputs 501. In the illustrated embodiment, inputs 501 comprise: P sets of textures 213 corresponding to the P training poses; P feature graphs 117 (FIG. 1), 267 (FIG. 2B) corresponding to the P training poses; neutral pose mesh 117 (FIG. 1), 257 (FIG. 2B); vertex proximity mask 309 (FIG. 4); approximation model 123 (FIG. 1), 340 (FIG. 4); rasterization matrix 127 (FIG. 1), 430 (FIG. 5); and a target facial expression (target pose) 503. Method 500 may be performed once for each target pose 503 (e.g. once per frame in an animation).

In general, target facial expression (target pose) 503 comprises a representation (e.g. a 3D mesh model or 3D mesh geometry) of a high-resolution facial expression (pose) which has the same topology as training poses 107A, thereby allowing for extraction (or otherwise allowing the determination) of low-resolution handle vertices corresponding to those used to create feature graphs 117. Target facial expression 503 may be obtained in any number of possible ways and formats depending on the application for which method 500 (block 130) is being applied.

In some embodiments, a high-resolution mesh captured from an actor serves as target facial expression 503. Such target facial expressions 503 may be used in block 130 (method 500), for example, in the context of an offline post-processing scenario when rendering CG characters in film projects. In some embodiments, when target facial expression 503 comes from captured images of an actor, the handle vertices used in prior steps of method 100 may not align directly with the captured vertices of facial expression 503, in which case a direct mapping between the high-resolution target facial expression 503 and the low-resolution handle vertices may be obtained using triangle vertex indices and barycentric coordinates. This mapping of vertices derived from captured images of an actor to desired vertices is well known in the field of computer animation and rendering. In such cases, it may be more efficient to derive the low-resolution geometry (from which the feature graphs 117 are obtained) after all operations have been applied for acquiring a plurality of target facial expressions 503 involved in rendering a particular scene, for example.

In some embodiments, a set of parameters which can be used to generate a target high-resolution 3D geometry/expression, such as a suitable set of blendshape weights, a blendshape basis and a blendshape neutral, are used to provide target facial expression 503 for method 500. The use of weighted combinations of blendshapes is commonly employed in real-time facial rendering applications as a parameterization of corresponding 3D geometries. In some situations, where target facial expression 503 is provided in the form of a set of blendshape weights, low-resolution blendshape weights may be obtained by downsampling the high-resolution blendshape basis (blendshapes), such that input facial expression blendshape weights 503 may be used (together with the downsampled blendshape basis) to obtain a corresponding low-resolution mesh geometry (e.g. handle vertices).

It will be appreciated that the above examples are merely examples of a number of suitable techniques that could be used for providing a target facial expression 503 that may be appropriate for use in real-time and offline applications of block 130 (method 500). Any suitable techniques may be used to provide target facial expression 503 as an input to method 100 (FIG. 1) and as an input to method 500 (FIG. 7).

Method 500 of the FIG. 7 embodiment comprises approximation computation sub-process 505 and weight-texture computation sub-process 550.

Approximation computation sub-process 505 begins at block 510. Block 510 comprises determining the feature graph geometry and corresponding edge characteristics (e.g. edge strains) and/or other suitable primitive parameters of the target facial expression 503. That is, block 510 involves determining a feature graph 513 (referred to herein as target feature graph 513) for target facial expression 503. Because target facial expression 503 has the same topology as training poses 107, there is a correspondence (or mapping) between the handle vertices of target facial expression 503 and those of the neutral pose mesh 257 (the feature graph geometry). Consequently, in some embodiments, block 510 involves extracting or otherwise determining these low-resolution handle vertices within the target facial expression 503. Extracting or otherwise determining the low-resolution handle vertices from target facial expression 503 in block 510 may be performed according to a number of different techniques, which are appropriate to the particular form of target facial expression 503 that is being used in method 500. A number of examples of extracting low-resolution geometries from high-resolution actor captures and from high-resolution blendshape weights are described above. Once the handle vertices are determined, the computation of the target feature graph 513 at block 510 may be similar to that described above for block 265 (FIG. 2B) and similarly employ equation (1) to determine a target feature graph vector ƒ=[ƒ₁ . . . ƒ^{F}]^{T}, as described above.

Method 500 and approximation computation sub-process 505 proceed to block 515, which represents a loop (in conjunction with block 535) with a number of steps that are performed for each high-resolution vertex v of target facial expression 503. Block 525 involves interpolating training pose weights from approximation model 123, 340 to thereby infer or otherwise determine blending weights 527 (also referred to herein as interpolation weights 527) for the current vertex v of target facial expression 503. Blending weights 527 may be defined in terms of the individual contributions of the P training poses 107A to the current vertex v of target facial expression using approximation model 123, 340 and, in the case of the illustrated embodiment, the RBF weights w for the current vertex v that are contained therein.

FIG. 7A is a schematic depiction of a method 700 that may be used to perform the block 525 process of inferring blending weights 527 for the current vertex v according to a particular embodiment. Method 700 receives input comprising: target feature graph 513 determined in block 510 (FIG. 7); vertex proximity mask 309 determined in block 307 (FIG. 4); training pose feature graphs 267 determined in block 265 (FIG. 2B); and approximation model 123, 340 determined in block 120/method 300 (FIGS. 1 and 4). Method 700 starts in block 710 which involves determining a similarity vector ϕ^{v,t} (715), which is a vector of length P representing a similarity of the v^{th} high-resolution vertex of target facial expression 503 to each of the P training poses 107A. Recalling from above that the variable k is used to index the P training poses 107A (k∈1, 2 . . . P), the k^{th} element ϕₖ^{v,t} of similarity vector ϕ_{v,t} (715) may be determined according to:

$${ϕ}_{k}^{v , t} = γ ( {\sum }_{i = 1}^{F} {{α}_{v , i} ( {( {f}_{t , i} - {f}_{k , i} )}^{{}_{2}} )}^{{}_{1 / 2}} \qquad ( 7 )$$

where: ϕₖ^{v,t} represents the k^{th} element of similarity vector ϕ^{v,t} (715) where the superscripts v and t indicate that similarity vector ϕ^{v,t} (715) corresponds to the v^{th} high-resolution vertex of the target facial expression t (503); γ an RBF kernel function (e.g. in some embodiments the biharmonic RBF kernel); ƒ_{t,i} the i^{th} element of the vector ƒₜ corresponding to the target feature graph 513 (i.e. the value determined by equation (1) for the i^{th} feature edge of the target feature graph 513); ƒ_{k,i} is the i^{th} element of the training pose feature graph 267 for the k^{th} training pose (i.e. the value determined by equation (1) for the i^{th} feature edge of the feature graph corresponding to the k^{th} training pose); α_{v,i} is the weight assigned to i^{th} feature edge based on its proximity to the current high-resolution vertex v (contained in proximity mask 309—e.g. through equation (2)); and the index i (i∈1, 2, . . . F) is the index that describes the number of edges in each feature graph. It will be observed that equation (7) is similar to equation (4) except that the index/(in equation (4)) is replaced by the index t (in equation (7)) and the index t (in equation (7) is fixed and refers to the target pose.

Once similarity vector ϕ^{v,t} (715) is determined, method 700 proceeds to block 720 which uses similarity vector ϕ^{v,t} (715) and approximation model 123, 340 to determine a vector tᵥ of length P blending weights 527 for the current high-resolution vertex v of target facial expression 503. In particular, the vector tᵥ of blending weights 527 for the current vertex v may be determined using the trained RBF weights matrix w (333—see FIG. 4) corresponding to the current vertex v. The block 720 determination of the vector tᵥ of blending weights 527 for the current vertex v may be determined according to:

$${t}_{v} = w \cdot {ϕ}^{v , t} \qquad ( 8 )$$

It will be appreciated that, while the equation (8) computation is effectively P scalar multiplication operations which can be computed relatively quickly (i.e. in real time). The output of method 700 (block 525) is a the vector tᵥ of blending weights 527 for the current high-resolution vertex v which is a set of weights corresponding to the similarity of target facial expression 503 to each of the P training poses 107A at the current high-resolution vertex v.

Returning to FIG. 7, block 530 may optionally be performed to normalize blending weights 527 (tᵥ) obtained in block 525 (method 700) to ensure that the P final per-vertex interpolation (blending) weights 527 (tᵥ) for target facial expression 503 add to 1. It is assumed, without loss of generality, that blending weights or interpolation weights 527 (tᵥ) discussed herein are normalized.

Method 500 then proceeds to decision block 535 which evaluates whether there are remaining vertices v of target facial expression 503 for which the approximation computation of sub-process 505 is to be performed. If the inquiry at block 535 is positive, method 500 increments the index of v and performs blocks 525, 530 for the subsequent vertex v of target facial expression 503 according to the steps described above. If the inquiry at block 535 is negative, then sub-process 505 ends and the output of approximation sub-process 505 comprises a set of per-high-resolution-vertex target facial expression (pose) blending weights 540 (i.e. P weights 527 (tᵥ) for each vertex v of target facial expression 503). For every high-resolution vertex v of target facial expression 503, target facial expression per-vertex blending weights 540 represent an associated approximation of that vertex's similarity to each of the P training poses 107A for the region proximate to that vertex v. As discussed above, target facial expression weights 540 comprise a vector tᵥ of length P for each high-resolution vertex v (v=1, 2, 3 . . . . V) of target facial expression 503.

According to some example embodiments, one or more optimizations may be applied in performing sub-process 505 to permit a smaller subset of high-resolution vertices to be interpolated during the real-time computation. In one particular example embodiment, approximation sub-process 505 computes only the blending weights 527 (tᵥ) for particular vertices v of target facial expression 503 which are known to surround (e.g. to be part of triangle or other polygons that surround) centers 470 of low-resolution cells 460 in notional grid 455 (i.e. the vertices that surround the UV coordinates of the pixels of weight texture map 575 in UV mapping 450; the vertices comprising a union of the vertices determined in block 415 over the N low-resolution pixels of weight texture map 575) (see FIGS. 5, 6A, 6B). This optimization is possible because once rasterization matrix 127, 430 has been determined in block 125 of FIG. 1/method 400 of FIG. 5 (preferably as part of a pre-processing step), it is known which high-resolution vertices (the vertices surrounding centers 470 of low-resolution cells 460 in notional grid 455 or the vertices surrounding the UV coordinates of the pixels of weight texture map 575 in UV mapping 450 or the vertices comprising a union of the vertices determined in block 415 over the N low-resolution pixels of weight texture map 575) are important for interpolating textures. Accordingly, the loop at blocks 515-535 can advantageously omit vertices which do not correspond to (e.g. surround or otherwise correspond to) centers 470 of low-resolution cells 460 or the pixels of weight texture map 575 or the vertices comprising a union of the vertices determined in block 415 over the N low-resolution pixels of weight texture map 575 to increase the speed of the real-time computation.

Following the completion of approximation sub-process 505, method 500 proceeds to texture-computation sub-process 550 for determining weight textures rₙ (for low-resolution weight texture map 575. As discussed in the context of determining the rasterization matrix 127, 430, the pixels of low-resolution weight texture map 575 used in texture-computation sub-process 550 map to UV space (in UV mapping 450) at the centers 470 of the cells 460 of notional grid 455 described above (FIGS. 5, 6A). Sub-process 550 may be performed as part of a real-time computation or as part of an offline computation. Sub-process 550 begins at block 555, which represents a loop (in conjunction with block 570) for performing a number of steps at each pixel n of low-resolution weight texture map 575 (or each cell 460 of notional grid 455), which may be indexed from 1≤n≤N. At block 560, the indices of the high-resolution vertices corresponding to the current low-resolution pixel n are selected. The indices of these high-resolution vertices may be obtained from the input rasterization matrix 127, 430, which may in turn be obtained according to example method 400 (FIG. 5). Block 560 may further comprise querying the vertex-specific interpolation (blending) weights 527 (tᵥ) from facial expression blending weights 540 to select the P-element interpolation weight vectors (tᵥ) for the identified high-resolution vertices v of the target facial expression 503 corresponding to the current pixel n). As discussed above, in some embodiments, other methods of choosing high-resolution vertices corresponding to a given low-resolution pixel n may be used. For example, in some embodiments, block 560 comprises selecting the P-element interpolation weight vector (tᵥ) from facial expression blending weights 540 for the one vertex most proximate to the center 470 of the UV cell 460 corresponding to the current pixel n (i.e. the one high-resolution vertex most proximate (in UV space) to the UV coordinates of the current pixel n of low-resolution weight texture map 575). As another example, block 560 may comprise selecting plurality of P-element interpolation weight vectors (tᵥ) from facial expression blending weights 540 for a number other than 3 of high-resolution vertices most proximate to the center 470 of the UV cell 460 corresponding to the current pixel n (i.e. a number other than 3 of high-resolution vertices most proximate (in UV space) to the UV coordinates of the current pixel n of low-resolution weight texture map 575).

Method 500 then proceeds to block 565, where a weight texture rₙ (567) for the current pixel n is computed. The block 565 weight texture 567 for current pixel n may be a vector rₙ having P elements (corresponding to the P training poses 107). In embodiments where multiple high-resolution vertices correspond to a pixel n (i.e. block 560 involves selecting multiple high-resolution vertices and multiple corresponding target facial expression weight vectors tᵥ from among target facial expression weight vectors 540), the target facial expression weight vector tᵥ corresponding to each block 560 vertex may be multiplied by the barycentric weight attributed to that vertex and these products may be added to one another to obtain a weight texture rₙ (567) having P elements for the current pixel n. For example, for a particular pixel n, there may be 3 high-resolution vertices (A, B, C) identified in block 560 and each of these vertices has: a barycentric coordinate (γ_{A}, γ_{B}, γC) which describes that vertex's relationship (in UV space) to the current pixel n (or, equivalently, to the center 470 of the current cell 460 corresponding to the current pixel n); and an associated P-element target facial expression blending weight 527 (t_{A}, t_{B}, t_{C}) determined in block 525, 530. Block 565 may comprise calculating weight texture rₙ (567) for the current pixel n according to rₙ=γ_{A}t_{A}+γ_{B}t_{B}+γ_{C}t_{C}. At the conclusion of block 565, a P-channel weight texture weight rₙ (567) corresponding to the current low-resolution pixel n is determined. As discussed above, in some embodiments, block 560 may involve determining only a single vertex for the current pixel n. Where there is a single vertex determined at block 560 for a particular pixel n, the block 565 weight texture rₙ (567) may correspond to the P-element target facial expression blending weight vector tᵥ for that vertex (selected from among target facial expression blending weight vectors 540).

Method 500 proceeds to decision block 570, which considers whether there are remaining pixels n for which the texture computation of sub-process 550 is to be performed. If the inquiry at block 570 is positive, method 500 increments the index of n and performs blocks 560 and 565 for the subsequent pixel n of low-resolution weight texture map 575 according to the steps described above. If the inquiry at block 570 is negative, then sub-process 550 ends with the output of a weight texture map 575 comprising N weight textures rₙ (567), each weight texture rₙ having P elements and each weight texture rₙ corresponding to one low-resolution pixel n of weight texture map 575 (e.g. one cell 460 of notional grid 455 described above in connection with method 400 (FIG. 5)).

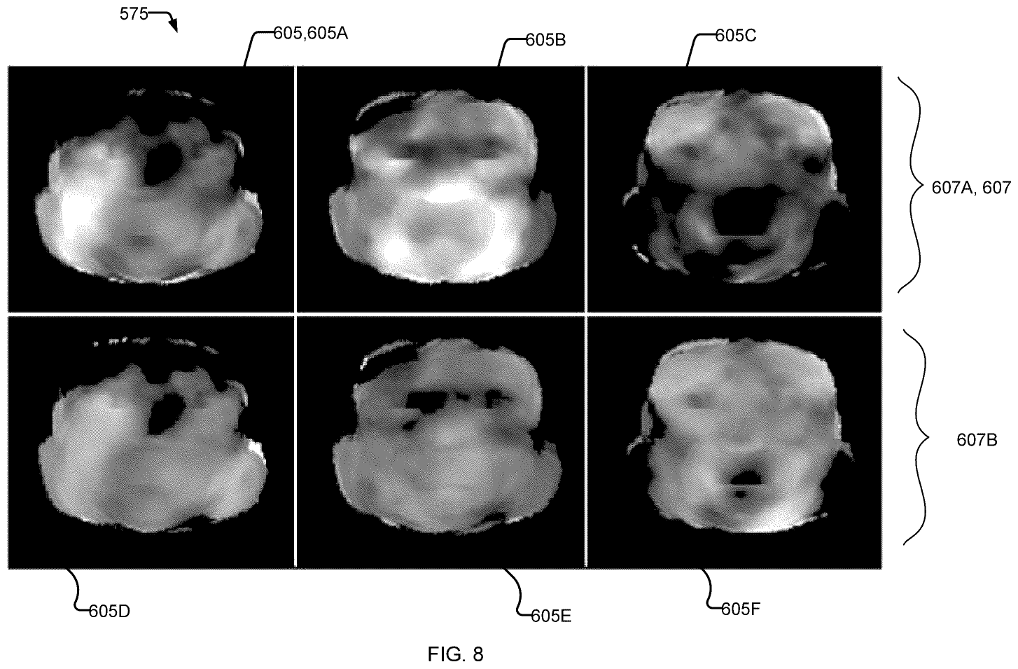

FIG. 8 illustrates an example weight texture map 575 (e.g. a weight texture vector rₙ (567) for each low-resolution pixel n) that may be uploaded to a graphics engine. Weight texture map 575 shown in FIG. 8 illustrate one exemplary representation of weight texture map 575 that may be output from the performance of method 500. Weight texture map 575 shown in FIG. 8 comprise six individual channel weight textures 605A, 605B, 605C, 605D, 605E, 605F (which may be referred to collectively, and/or individually, as channel weight textures 605), each channel weight texture 605 corresponding to one channel of RGB channels typically used in graphics engines. In the illustrated FIG. 8 example, weight texture map 575 and channel weight textures 605 comprise a 128×128 low-resolution UV mapping of pixels. That is, weight texture map 575 shown in the FIG. 8 example embodiment comprises a resolution of 128×128 pixels (or, equivalently, 128×128 cells 460 in notional grid 455 explained above in connection with FIGS. 5 and 6A). In the illustrated FIG. 8 example, P=6, so weight texture map 575 comprises P=6 elements (vectors rₙ of length P=6) for each low-resolution pixel n in the 128×128 grid and these P=6 elements (vectors rₙ of length P=6) represent a similarity of a target facial expression 503 to each of the P=6 training poses. Since graphics engines typically use images comprising three RGB channels, channel weight textures 605A, 605B, 605C, 605D, 605E, 605F may be provided as two RGB weight textures 607A, 607B (collectively and/or individually RGB weight textures 607), with one channel weight texture 605 in each of the RGB channels of RGB weight textures 607. Each pixel n shown in FIG. 8 stores information regarding the corresponding weight texture rₙ for a target facial expression 503, with one element of weight texture vector rₙ in each of the six RGB colour channels (one weight texture element in each of the RGB channels of each of the two RGB weight textures 607). In this manner, each channel weight texture 605 stores one element of weight texture rₙ for each pixel n of weight texture map 575 and two RGB weight textures 607 store P=6 elements.

The illustrated FIG. 8 example may be appropriate in cases where P=6 (or other multiples of 3) training poses are utilized for performing method 100 and weight textures 567 (vectors rₙ) comprise P=6 (or other multiples of 3) elements for each low-resolution pixel n. As there are two RGB weight textures 607 in the FIG. 8 example, RGB weight textures 607 comprise a total of six training pose weight texture elements (i.e. one element of weight texture rₙ for each of the RGB channels for two RGB weight textures 607). The representation of weight texture elements in the form of RGB color channels (channel weight textures 605) may be advantageous in scenarios where graphics engines (e.g. graphics processing units (GPUs)) are used for Interpolating the final high-resolution textures of for target facial expression 503, as GPUs are able to easily accommodate RGB data inputs. Such example scenarios are discussed below. For example, based on the combination of the high-resolution skin textures contained in the P texture sets 213 (FIG. 2A) and weight texture map 575 (FIGS. 7, 8), a graphics engine may be provided with six diffuse colours, six specular colours, and so on for each texture of interest, each colour corresponding to a different one of the P training poses 107A with a corresponding weight.

The principles illustrated in FIG. 8 and in weight textures 605, 607 may be applied in embodiments of method 100 having different computational parameters. For example, where the number P of training poses P in training the approximation model at block 120 of method 100 is P=3 or P=9, a single one or three of RGB weight texture(s) 607 (three channel weight textures 605) may be employed for representing the appropriate number of elements of weight textures 567 (vectors rₙ) for each low-resolution pixel n. It is also not necessary that every colour channel stores data relating to weight textures 567 (vectors rₙ). For example, where the number of training poses in an application of method 100 is P=5, weight texture map 575 may be represented by two RGB weight textures 607A and 607B, similar to that illustrated in FIG. 8. However, as only P=5 training pose texture elements need to be represented, RGB weight texture 607B may store weights relating to the training poses in only the red and green channels (for a total of P=5 channel weight textures 605), with the blue channel being empty or used for a different purpose. Different data types and data structures are also possible for representing and storing weight texture map 575. For example, weight texture map 575 may be represented in the CMYK color space containing 4 channels, in contrast to the 3 channels of the RGB colour space. This may be advantageous in scenarios where the textures of P=4 or P=8 (or other multiples of 4) training poses 107A are interpolated, for example. In other embodiments, weight texture map 575 are not represented by colour channels, but instead comprise a single multi-channel attribute texture which accommodates all P elements for each low-resolution pixel n.

Returning to method 500 (FIG. 7), following the completion of sub-process 550, method 500 proceeds to block 580, where high-resolution target facial expression 503 is rendered with textures modified by weight textures 567 (vectors rₙ) to provide rendered facial image 585. As described in more detail below, this block 580 rendering process may involve interpolation between the P input textures of each type based on weight textures 567 (vectors rₙ) and may also involve interpolation based on the UV coordinates of each pixel (an image pixel) being rendered and texture values at corresponding high-resolution texels and weight textures 567 (vectors rₙ) at low-resolution pixels n. There are a number of possible ways in which block 580 can be performed. In some embodiments, the low-resolution weight textures 567 (vectors rₙ-one per low-resolution pixel n) are input into a graphics engine (e.g. GPU) at block 580. The P sets of high-resolution textures 213 corresponding to the P training poses 107A (FIG. 2A) may be pre-loaded into the graphics engine prior to or at the time of performing block 580. By way of non-limiting example, the P sets of high-resolution textures 213 may comprise textures for diffuse, ambient occlusion, normal, bent normals, specular, and/or the like. In some embodiments, the graphics engine comprises shader software to extract the interpolation weights for target facial expression 503 from weight texture map 575 and to interpolate the P sets of pre-loaded high-resolution textures 213.

As an example of such a block 580 interpolation, consider a particular high-resolution pixel of the image to be rendered (an image pixel) and a particular texture type (e.g. diffuse) to be interpolated. If we assume that the image pixel maps to UV space at the center of a corresponding high-resolution texel of the P high-resolution textures 213 to be interpolated, then these P high-resolution textures 213 may return corresponding values of tex₁, tex₂, tex₃ . . . tex_{P}, where these values are the precise texture values of the corresponding texel. If we assume further that the image pixel maps to UV space at the center of a low-resolution pixel n in weight textures 567, then this corresponds exactly to the weight texture vector rₙ corresponding to that low-resolution pixel. In this example scenario, the rendered texture value for the particular texture type for the particular high-resolution image pixel could be interpolated according to the example expression:

$$texture = {tex}_{1} \cdot {r}_{1} + t e {x}_{2} \cdot {r}_{2} + … {tex}_{P} \cdot {r}_{P} \qquad ( 9 )$$

Where: texture is the texture value to be rendered for the particular high-resolution image pixel and r₁, r₂ . . . r_{P} are the P elements of the weight texture vector rₙ corresponding to the low-resolution weight-texture pixel n.

In some embodiments, it might be desirable to perform more sophisticated interpolation techniques in block 580, which take into account the continuous UV coordinates between neighboring high-resolution texels of the P corresponding texture sets and/or between neighbouring low-resolution pixels n for which weight textures 567 (vectors rₙ) are known. For example, the image pixel being rendered may not map directly to the center of a high-resolution texel of the P textures 213 in UV space and may instead map to UV space somewhere between a number of high-resolution texels. In such a case, a suitable texture filtering technique (also known as texture querying or texture sampling) can be used to interpolate between the texture values of the neighboring high-resolution texels. By way of non-limiting example, such a texture filtering technique could comprise bilinear interpolation, cubic interpolation, some other form of interpolation (any of which could be user-defined) and/or the like between texture values of neighboring high-resolution texels. In such cases, the equation (9) values of tex₁, tex₂, tex₃ . . . tex_{P} may be considered to be the texture-queried values (e.g. interpolated between high-resolution texels) from the P training textures.

Similarly, the image pixel being rendered may not map directly to the center of a low-resolution pixel n in UV space and may instead map to UV space somewhere between a number of low-resolution pixels. In such a case, a suitable weight-texture filtering technique (also potentially referred to herein as a weight-texture querying) can be used to interpolate between weight textures 567 (vectors rₙ) of neighboring low-resolution pixels to obtain an interpolated weight texture vector r*. By way of non-limiting example, such a weight-texture filtering technique could comprise bilinear interpolation, cubic interpolation, some other form of interpolation (any of which could be user-defined) and/or the like between weight textures 567 (vectors rₙ) of neighboring low-resolution pixels to obtain the interpolated (weight-texture filtered or weight-texture queried) weight texture vector r*. In such cases, the equation (9) values of r₁, r₂ . . . r_{P} may be considered to be the elements of the weight-texture-queried weight texture vector r* interpolated between weight textures 567 (vectors rₙ) of neighboring low-resolution pixels. Such interpolation techniques can advantageously mitigate the fact that weight textures 567 are provided at a low resolution (vectors rₙ—one per low-resolution pixel n) and allow for a smooth transition of interpolating weights between regions of the face, avoiding or mitigating artifacts (visible seams or edges) in the blended high-resolution textures rendered over the face.

Without wishing to be bound by theory, it is believed by the inventors that low-resolution weight textures 567 (vectors rₙ—one per low-resolution pixel n) can be reliably upscaled (or interpolated) to achieve higher resolutions having desirable visual outcomes using the methods described herein. The use of approximation model 123, 340 in embodiments of the present invention achieves local consistency on the solved interpolation weights (e.g. per-vertex facial expression blending weights 540 (including blending weights 527 (tᵥ) for each vertex v) as nearby output vertices are influenced by a similar set of feature edges and therefore result in similar influence weights from the various training poses.

Graphics engines described herein generally refer to computer hardware and associated software which receive a set of software instructions and inputs to process and render animated 3D graphics. These graphics engines typically comprise shader software for producing detailed textures and colours in 3D scenes. The software instructions carried out by graphics engines are typically compiled and executed on one or more GPUs, but may also be carried out through one or more central processing units (CPUs). Examples of graphics engines appropriate for use with the present invention include, but are not limited to, Unreal Engine™, Unity™, Frostbite™ and CryEngine™. In some embodiments, the application of weight textures 567 (vectors rₙ) to a target facial expression 503 and rendering of target facial expressions 503 as images 585 at block 130 of method 100 is performed entirely by a suitable graphics engine. In other embodiments, only the rendering of the high-resolution textures at block 580 of method 500 is performed by the graphics engine, while other portions of method 500 are implemented using one or more other suitable computer processors.

Method 500 ends following the rendering of target facial expression 503 modified by weight textures 567 (vectors rₙ) to provide rendered facial expression 585 at block 580. Returning to method 100 (FIG. 1), method 100 may optionally proceed to decision block 135 which evaluates if the performance of the application of textures to target facial expression 503 and rendering of target facial expression 503 (i.e. rendered facial expression 585) at block 130 is satisfactory. In some embodiments, the determination at block 135 is based on whether the target frame rate and/or the desired resolution defined in computational parameters 113 has been achieved by the real-time computation at block 130.

If the inquiry at decision block 135 is negative, then method 100 returns to block 110 where new computational parameters 113 may be defined to better meet desired metrics. Performance may be deemed unsatisfactory if a desired frame rate is not achieved or if the GPU usage exceeds defined limits, for example. Defining new computational parameters 113 may comprise one or more of:
reducing the number of training poses;
reducing the granularity of the low-resolution weight texture map 575 (e.g. the resolution of UV mapping 450); and
reducing the resolution of the high-resolution textures.

In some embodiments, the block 135 determination of whether the performance of the real-time computation is satisfactory is based on evaluating the quality of the rendered facial expression 585 (see FIG. 1 and FIG. 7). For example, the quality of rendered facial expression 585 may be defined according to one or more of:
whether the number of types of high-resolution textures which are used (e.g. specular, diffuse, etc.) accurately depicts the range of details (e.g. wrinkles) which appear or disappear based on the current facial expression;
whether the granularity of the low-resolution weight texture map 575 subdivides the face into enough regions (e.g. the number or low-resolution pixels Nin in weight texture map 575 or in UV mapping 450 (FIG. 5, FIG. 6) which adequately distinguish the effects of a facial expression on the resulting textures; and
whether the high-resolution textures contain enough rendered details.

In some embodiments, where the quality of the rendered facial expression 585 is determined to be insufficiently high, any of the above inputs to method 100 may be appropriately changed. This may comprise, for example, capturing more high-resolution textures, increasing the granularity of the low-resolution weight texture, and increasing the number of high-resolution vertices. In some embodiments, such changes may be accompanied by corresponding changes in computational parameters 113 (e.g. by lowering a target frame rate when more high-resolution textures are applied). In some embodiments, the block 135 evaluation may be performed in whole or in part by a human artist or other user.

If the evaluation at block 135 is positive, then method 100 ends. Through the performance of method 100 and the methods described herein, photo-realistic texture details which vary with changing real-time facial expressions can be achieved in a computationally efficient manner.

In some embodiments, the rasterization computation of block 125 of method 100 (FIG. 1 and FIG. 5) and the corresponding rasterization matrices 127 (shown in dashed lines in FIG. 1) are not required and are optional parts of method 100. In such embodiments, the low-resolution 2D mapping 450 and corresponding notional grid 455 (determined in block 410 of method 400) may be replaced by the high-resolution pixels in the 2D space of the image being rendered in block 130 and block 130 may be modified for performing the interpolation on the high-resolution pixels in the 2D space of the image being rendered (rather than on the low-resolution pixels mapped to the 2D UV space of the block 125 rasterization).

In some such embodiments, rather than block 130 of FIG. 1 being performed by method 500 of FIG. 7, block 130 of FIG. 1 may be performed by implementing method 750 shown in FIG. 7B, Method 750 of FIG. 7B may have a number of steps that are the same as or similar to the steps of method 700 of FIG. 7 and similar reference numerals are used to refer to such steps. The inputs to method 750 differ from those of method 700 in that rasterization matrices 127, 430 are not inputs to method 750. The approximation computation 505 of method 750 may be substantially the same as that for method 700 described above and, as described above, may result in per-vertex blending weights 540 for target facial expression 503 (i.e. P weights 527 (tᵥ) for each vertex v of target facial expression 503). For every high-resolution vertex v of target facial expression 503, target facial expression per-vertex blending weights 540 represent an associated approximation of that vertex's similarity to each of the P training poses 107A for the region proximate to that vertex v. As discussed above, target facial expression weights 540 comprise a vector tᵥ of length P for each high-resolution vertex v (v=1, 2, 3 . . . V) of target facial expression 503.

At the conclusion of approximation computation 505, method 750 may proceed to block 752 rendering process. The block 752 rendering process of method 750 is analogous to a combination of texture computation (block 550) and rendering (block 580) of method 700, except that the procedures of the block 752 rendering process are performed in the 2D space of the image (and corresponding pixels) corresponding to target facial expression 503 that is being rendered. In practice, the procedures of the block 752 rendering process may be performed by a graphics processing unit based on the per-vertex blending weights 540 for target facial expression 503 (i.e. P weights 527 (tᵥ) for each vertex v of target facial expression 503) which may be output from approximation computation 505 and passed to the graphics processing unit as per-vertex attributes.

The block 752 rendering comprises a loop that is performed once for each high-resolution pixel n in the plurality of N high-resolution pixels in the 2D image that is being rendered in correspondence with target facial expression 503. The output of the block 752 rendering process is an rendered facial image 585 corresponding to target facial expression 503. It will be appreciated that the variables n and N still correspond to individual pixels n and a total number of pixels N, except that in the context of method 750, these are pixels in the 2D space of the image being rendered (rather than in a 2D UV space as is the case for method 700). For each pixel n (n∈{1, 2, . . . N}) in the 2D space of the rendered image, the block 752 rendering comprises block 756 which involves selecting corresponding vertices and corresponding target expression per-vertex weights (tᵥ) corresponding to the current pixel n. The selection of vertices in block 756 may be analogous to that of block 560 (of method 700) or to that of blocks 415 and 425 (of method 400-FIG. 5) described above, except that for block 756, the 2D space is that of the image being rendered. As discussed above in relation to block 560, 415 and 425, selection of the vertices corresponding to the current pixel n in block 756 may involve selecting the triangle of vertices which, when mapped to the 2D space, are closest to the current pixel n and determining corresponding barycentric coordinates. In some embodiments, selection of the vertices corresponding to the current pixel n in block 756 may involve selecting a single vertex (or some plurality other than three vertices) which, when mapped to the 2D space, is/are closest to the current pixel n. As was the case for block 560 discussed above, once the vertices are determined, their corresponding target expression per-vertex weights (tᵥ) are also known.

The block 752 rendering process then proceeds to block 758 which involves computing per-pixel blending weights rₙ (760) for the current pixel n. The block 758 procedure may be analogous to the block 565 procedure for computing per-low-resolution pixel weight textures rₙ (567) discussed above, except that the 2D space on which the per-pixel blending weights rₙ (760) are computed in block 758 is the 2D space of the image being rendered and the pixels n are those of image being rendered. It will be appreciated that weight textures rₙ (567) discussed above may be also be considered to be “per-pixel blending weights” rₙ (567), except that the 2D spaces and corresponding pixels for per-pixel blending weights rₙ (567) and per-pixel blending weights rₙ (760) are different.

The block 758 per-pixel blending weight 760 for current pixel n may be a vector rₙ having P elements (corresponding to the P training poses 107). In embodiments where multiple high-resolution vertices correspond to a pixel n (i.e. block 756 involves selecting multiple high-resolution vertices and multiple corresponding target facial expression weight vectors ty), the target facial expression weight vector tᵥ corresponding to each block 756 vertex may be multiplied by the barycentric weight attributed to that vertex and these products may be added to one another to obtain the per-pixel blending weight rₙ (760) having P elements for the current pixel n. For example, for a particular pixel n, there may be 3 high-resolution vertices (A, B, C) identified in block 756 (e.g. a triangle defined by the vertices (A, B, C) and the particular pixel n has barycentric coordinate (γ_{A}, γ_{B}, γ_{C}) which describe the relationship of the pixel n (in the 2D space of the image being rendered) to the vertices (A, B, C); and an associated P-element target facial expression blending weight 527 (t_{A}, t_{B}, t_{C}) determined in block 525, 530. Block 758 may comprise calculating per-pixel blending weight rₙ (760) for the current pixel n according to rₙ=γ_{A}t_{A}+γ_{B}t_{B}+γ_{C}t_{C}. At the conclusion of block 758, a P-channel blending weight rₙ (760) corresponding to the current pixel n is determined. As discussed above, in some embodiments, block 756 may involve determining only a single vertex for the current pixel n. Where there is a single vertex determined at block 756 for a particular pixel n, the block 758 blending weight rₙ (760) may correspond to the P-element target facial expression blending weight vector tᵥ for that vertex.

The block 752 rendering process then proceeds to block 762 which involves rendering the current pixel n of rendered facial image 585 corresponding to target facial expression 503 using textures interpolated on the basis of per-pixel blending weights rₙ (760). Block 762 of method 750 is analogous to block 580 of method 700, except that the block 762 procedure is performed for the current high-resolution pixel n of the image 585 being rendered (the image pixel). In particular, block 762 involves rendering high-resolution target facial expression 503 with textures modified by per-pixel blending weights 760 (vectors rₙ) to provide texture values for the current pixel n of rendered facial image 585. Like block 580, the block 762 rendering process may involve interpolation between the P input textures of each type based on per-pixel blending weights 760 (vectors rₙ) and may also involve interpolation based on the UV coordinates of the image pixel and texture values at corresponding texels. As discussed above, the P sets of high-resolution textures 213 corresponding to the P training poses 107A (FIG. 2A) may comprise textures for diffuse, ambient occlusion, normal, bent normals, specular, and/or the like. As an example of the block 762 interpolation, consider a particular texture type (e.g. diffuse), where tex₁, tex₂, tex₃ . . . tex_{P} are the texture-queried values of the P high-resolution textures 213 (corresponding to the P training poses) for the particular texture type corresponding to a particular high-resolution image pixel n in the 2D space of the image 585 being rendered. See the discussion above (in the description of block 580) relating to texture querying or texture filtering. As discussed above, by way of non-limiting example, such a texture filtering technique could comprise bilinear interpolation, cubic interpolation, some other form of interpolation (any of which could be user-defined) and/or the like between texture values of neighboring texels. In such a scenario, the rendered texture value for the particular texture type could be interpolated according to the example expression:

$$texture = {tex}_{1} \cdot {r}_{1} + t e {x}_{2} \cdot {r}_{2} + … {tex}_{P} \cdot {r}_{P} \qquad ( 10 )$$

Where: texture is the texture value to be rendered for the current high-resolution image pixel n and r₁, r₂ . . . r_{P} are the P elements of the weight texture vector rₙ corresponding to the current high-resolution image pixel n.

The block 752 rendering process then proceeds to block 764 which involves an inquiry into whether there are more pixels n which need to be rendered. If so, then the block 752 rendering process loops back to perform blocks 756, 758 and 762 for the next pixel n. When all N pixels in the 2D space of the image 585 have been rendered, then the block 752 rendering process is complete for the current target facial expression 583.

In practice, the procedures of rendering block 752 may be performed by a graphics processing unit while rendering target facial expression 503, where the per-vertex blending weights 527 (tᵥ) obtained in block 525, 530 may be passed to the graphics processing unit as a user-defined per-vertex attribute.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.
Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

In some embodiments, the invention may be implemented in software. For greater clarity, “software” includes any instructions executed on a processor, and may include (but is not limited to) firmware, resident software, microcode, and the like. Both processing hardware and software may be centralized or distributed (or a combination thereof), in whole or in part, as known to those skilled in the art. For example, software and other modules may be accessible via local memory, via a network, via a browser or other application in a distributed computing context, or via other means suitable for the purposes described above.

Processing may be centralized or distributed. Where processing is distributed, information including software and/or data may be kept centrally or distributed. Such information may be exchanged between different functional units by way of a communications network, such as a Local Area Network (LAN), Wide Area Network (WAN), or the Internet, wired or wireless data links, electromagnetic signals, or other data communication channel.

Software and other modules may reside on servers, workstations, personal computers, tablet computers, image data encoders, image data decoders, PDAs, color-grading tools, video projectors, audio-visual receivers, displays (such as televisions), digital cinema projectors, media players, and other devices suitable for the purposes described herein. Those skilled in the relevant art will appreciate that aspects of the system can be practiced with other communications, data processing, or computer system configurations, including: Internet appliances, hand-held devices (including personal digital assistants (PDAs)), wearable computers, all manner of cellular or mobile phones, multi-processor systems, microprocessor-based or programmable consumer electronics (e.g., video projectors, audio-visual receivers, displays, such as televisions, and the like), set-top boxes, color-grading tools, network PCs, mini-computers, mainframe computers, and the like.

Embodiments of the invention may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”)). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors may implement methods as described herein by executing software instructions in a program memory accessible to the processors.

While processes or blocks described herein are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

In addition, while elements are at times shown as being performed sequentially, they may instead be performed simultaneously or in different sequences. It is therefore intended that the following claims are interpreted to include all such variations as are within their intended scope.

The invention may also be provided in the form of a program product. The program product may comprise any non-transitory medium which carries a set of computer-readable instructions which, when executed by a data processor, cause the data processor to execute a method of the invention. Program products according to the invention may be in any of a wide variety of forms. The program product may comprise, for example, non-transitory media such as magnetic data storage media including floppy diskettes, hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable signals on the program product may optionally be compressed or encrypted.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

The invention has a number of non-limiting aspects. Non-limiting aspects of the invention comprise:

1. A method for determining a high-resolution texture for rendering a target facial expression, the method comprising:
(a) obtaining a plurality of P training facial poses, each of the P training facial poses comprising:
   V high-resolution vertices and training-pose positions of the Vhigh-resolution vertices in a three-dimensional (3D) coordinate system; and
   at least one two-dimensional (2D) texture;
(b) obtaining a target facial expression, the target facial expression comprising the Vhigh-resolution vertices and target-expression positions of the V high-resolution vertices in the 3D coordinate system;
(c) determining a target feature graph comprising a plurality of target feature graph parameters for the target facial expression based at least in part on the target facial expression and a neutral pose selected from among the P training poses;
(d) determining training feature graphs comprising pluralities of training feature graph parameters for the P training facial poses, each of the training feature graphs based at least in part on one of the P training facial poses and the neutral pose;
(e) for each of a plurality of high-resolution vertices v from among the V high-resolution vertices, determining a plurality of blending weights tᵥ based at least in part on: an approximation model trained using the P training facial poses; and a similarity metric ϕ^{v,t} which represents a similarity of the target feature graph at the vertex v to each of the training feature graphs;
(f) for each pixel n in a plurality of N pixels in a 2D space:
   (f.1) determining one or more corresponding vertices from among the plurality of high-resolution vertices v that correspond with the pixel n based at least in part on 2D coordinates of the pixel n in the 2D space and a mapping of the plurality of high-resolution vertices v to the 2D space which provides 2D coordinates of the plurality of high-resolution vertices v in the 2D space; and
   (f.2) determining a set of per-pixel blending weights rₙ for the pixel n based at least in part on the blending weights tᵥ for the one or more corresponding vertices, the set of per-pixel blending weights rₙ comprising a weight for each of the P training facial poses; and
(g) for each high-resolution pixel in a 2D rendering of the target facial expression, interpolating the 2D textures of the P training facial poses based at least in part on the per-pixel blending weights rₙ to thereby provide a target texture for the high-resolution pixel.
   2. The method of aspect 1 or any other aspect herein wherein determining the training feature graphs for the P training poses comprises determining a plurality of W low-resolution handle vertices, where the W handle vertices are a low-resolution subset of the Vhigh-resolution vertices where W<V.
   3. The method of aspect 2 or any other aspect herein wherein determining the training feature graphs for the P training poses comprises, for each of the P training facial poses:
determining a training feature graph geometry corresponding to the training facial pose, the training feature graph geometry comprising a plurality of F feature edges defined between the training-pose positions of corresponding pairs of the plurality of low-resolution W handle vertices for the training pose;
determining the plurality of training feature graph parameters to be a plurality of F training feature graph parameters corresponding to the F feature edges, each of the plurality of F training feature graph parameters based at least in part on the corresponding feature edge of the training facial pose and the corresponding feature edge of the neutral pose;
to thereby obtain the P training feature graphs, each of the P training feature graphs comprising a corresponding plurality of F training feature graph parameters.
   4. The method aspect 3 or any other aspect herein wherein determining the plurality of F training feature graph parameters corresponding to the F feature edges comprises, for each of the plurality of F training feature graph parameters, determining the training feature graph parameter using an equation of the form

$${f}_{i} = ( ‖ {p}_{i , 1} - {p}_{i , 2} ‖ - {l}_{i} ) / {l}_{i} \qquad ( 1 )$$

where: ƒᵢ is the i^{th} training feature graph parameter corresponding to the i^{th} feature edge; p_{i,1} and p_{i,2} are the training-pose positions of the handle vertices that define endpoints of ƒᵢ; and lᵢ is a length of the corresponding i^{th} feature edge in the neutral pose.
5. The method of aspect 2 or any other aspect herein wherein determining the training feature graphs for the P training poses comprises, for each of the P training facial poses:
determining a training feature graph geometry corresponding to the training facial pose, the training feature graph geometry comprising a plurality of F feature edges defined between the training-pose positions of corresponding pairs of the plurality of low-resolution W handle vertices for the training pose;
determining the plurality of training feature graph parameters, each of the plurality of training feature graph parameters based at least in part on some or all of the F feature edges of the training facial pose and some or all of the feature edges of the neutral pose;
to thereby obtain the P training feature graphs, each of the P training feature graphs comprising a corresponding plurality of training feature graph parameters.
   6. The method of any one of aspects 1 and 5 or any other aspect herein wherein determining the training feature graphs for the P training poses comprises, for each of the P training facial poses:
determining the plurality of training feature graph parameters, each of the plurality of training graph feature parameters based at least in part on one or more primitive parameters determined based at least in part on the training facial pose and the neutral pose;
to thereby obtain the P training feature graphs, each of the P training feature graphs comprising a corresponding plurality of training feature graph parameters.
   7. The method of aspect 6 or any other aspect herein wherein determining the plurality of training feature graph parameters comprises determining one or more of: deformation gradients based at least in part on the training facial pose and the neutral pose; pyramid coordinates based at least in part on the training facial pose and the neutral pose; triangle parameters based at least in part on the training facial pose and the neutral pose; and 1-ring neighbor parameters based at least in part on the training facial pose and the neutral pose.
   8. The method of any one of aspects 2 to 4 or any other aspect herein wherein determining the target feature graph comprises:
determining a target feature graph geometry corresponding to the target facial expression, the target feature graph geometry comprising a plurality of F feature edges defined between the target-expression positions of corresponding pairs of the plurality of low-resolution W handle vertices for the target expression;
determining the plurality of target feature graph parameters to be a plurality of F target feature graph parameters corresponding to the F feature edges, each of the plurality of F target feature graph parameters based at least in part on the corresponding feature edge of the target facial expression and the corresponding feature edge of the neutral pose;
to thereby obtain the target feature graph comprising the plurality of F target feature graph parameters.
   9. The method aspect 8 or any other aspect herein wherein determining the plurality of F target feature graph parameters corresponding to the F feature edges comprises, for each of the plurality of F target feature graph parameters, determining the target feature graph parameter using an equation of the form

$${f}_{i} = ( ‖ {p}_{i , 1} - {p}_{i , 2} ‖ - {l}_{i} ) / {l}_{i} \qquad ( 1 )$$

where: ƒᵢ is the i^{th} target feature graph parameter corresponding to the i^{th} feature edge; p_{i,1} and p_{i,2} are the target-expression positions of the handle vertices that define endpoints of ƒᵢ; and lᵢ is a length of the corresponding i^{th} feature edge in the neutral pose.
10. The method of aspect 5 or any other aspect herein wherein determining the target feature graph comprises:
determining a target feature graph geometry corresponding to the target facial expression, the target feature graph geometry comprising a plurality of F feature edges defined between the target-expression positions of corresponding pairs of the plurality of low-resolution W handle vertices for the target facial expression;
determining the plurality of target feature graph parameters, each of the plurality of target feature graph parameters based at least in part on some or all of the F feature edges of the target facial expression and some or all of the feature edges of the neutral pose;
to thereby obtain the target feature graph comprising the plurality of target feature graph parameters.
   11. The method of any one of aspects 6 and 7 or any other aspect herein wherein determining the target feature graph comprises:
determining a plurality of target feature graph parameters, each of the plurality of target graph feature parameters based at least in part on one or more primitive parameters determined based on the target facial expression and the neutral pose;
to thereby obtain the target feature graph comprising the plurality of target feature graph parameters.
   12. The method of aspect 11 or any other aspect herein wherein determining the plurality of target feature graph parameters comprises determining one or more of: deformation gradients based at least in part on the target facial expression and the neutral pose; pyramid coordinates based at least in part on the target facial expression and the neutral pose; triangle parameters based at least in part on the target facial expression and the neutral pose; and 1-ring neighbor parameters based at least in part on the target facial expression and the neutral pose.
   13. The method of any one of aspects 1 to 12 or any other aspect herein wherein determining the one or more corresponding vertices from among the plurality of high-resolution vertices v that correspond with the pixel n is based at least in part on a proximity of the 2D coordinates of the one or more corresponding vertices to the 2D coordinates of the pixel n.
   14. The method of aspect 13 or any other aspect herein wherein determining the one or more corresponding vertices from among the plurality of high-resolution vertices v that correspond with the pixel n comprises determining the three vertices with 2D coordinates most proximate to the 2D coordinates of the pixel n, to thereby define a triangle around the pixel n in the 2D space.
   15. The method of aspect 13 or any other aspect herein wherein determining the one or more corresponding vertices from among the plurality of high-resolution vertices v that correspond with the pixel n comprises determining barycentric coordinates for the triangle relative to the 2D coordinates of the pixel n.
   16. The method of aspect 13 or any other aspect herein wherein determining the one or more corresponding vertices from among the plurality of high-resolution vertices v that correspond with the pixel n comprises determining the one vertex with 2D coordinates most proximate to the 2D coordinates of the pixel n.
   17. The method of any one of aspects 1 to 16 or any other aspect herein comprising selecting the plurality of high-resolution vertices v from among the Vhigh-resolution vertices to be a union of the one or more high-resolution vertices determined to correspond with each pixel n in the plurality of N pixels; and wherein selecting the plurality of high-resolution vertices v from among the Vhigh-resolution vertices is performed prior to step (e) so that step (e) is performed only for the selected plurality of high-resolution vertices v from among the Vhigh-resolution vertices.
   18. The method of any one of aspects 1 to 16 comprising selecting the plurality of high-resolution vertices v from among the V high-resolution vertices to be all of the V high-resolution vertices.
   19. The method of aspect 15 or any other aspect herein wherein determining the set of per-pixel blending weights rₙ for the pixel n comprises determining the set of per-pixel blending weights rₙ for the pixel n based at least in part on the blending weights tᵥ for the three vertices that define the triangle around the pixel n in the 2D space and the barycentric coordinates of the triangle relative to the 2D coordinates of the pixel n.
   20. The method of any one of aspects 15 and 19 or any other aspect herein wherein determining the set of per-pixel blending weights rₙ for the pixel n comprises performing an operation of the form rₙ=γ_{A}t_{A}+γ_{B}t_{B}+γ_{C}t_{C} where t_{A}, t_{B}, t_{C} represent the blending weights tᵥ determined in step (e) for the three vertices that define the triangle around the pixel n in the 2D space and γ_{A}, γ_{B}, γ_{C} represent the barycentric coordinates for the triangle relative to the 2D coordinates of the pixel n.
   21. The method of aspect 16 wherein determining the set of per-pixel blending weights rₙ for the pixel n comprises determining the set of per-pixel blending weights rₙ for the pixel n to be the blending weights tᵥ determined in step (e) for the one vertex with 2D coordinates most proximate to the 2D coordinates of the pixel n.
   22. The method of any one of aspects 1 to 21 or any other aspect herein wherein the 2D space is a 2D space of the 2D rendering.
   23. The method of any one of aspects 1 to 21 or any other aspect herein wherein the 2D space is different from that of the 2D rendering.
   24. The method of aspect 23 or any other aspect herein wherein the 2D space is a UV space.
   25. The method of any one of aspects 23 to 24 or any other aspect herein wherein the plurality of N pixels in the 2D space have a resolution that is lower than that of the pixels in the 2D rendering.
   26. The method of any one of aspects 23 to 25 or any other aspect herein wherein interpolating the 2D textures of the P training facial poses is based at least in part on a location of the high-resolution pixel mapped to the 2D space.
   27. The method of any one of aspects 1 to 26 or any other aspect herein comprising determining the approximation model based at least in part on the training feature graphs of the P training facial poses.
   28. The method of aspect 27 or any other aspect herein wherein determining the approximation model comprises, for each high-resolution vertex v of the Vhigh-resolution vertices:
solving an equation of the form w=dϕ⁻¹ where:
   d is a P-dimensional identity matrix; and
   ϕ is a P×P dimensional matrix of weighted radial basis functions (RBFs) where each element of ϕ is based at least in part on comparing the training feature graph parameters of the P training feature graphs;
to thereby obtain a P×P dimensional matrix of RBF weights w corresponding to the high-resolution vertex v,
to thereby define an approximation model which comprises a set of VRBF weight matrices w.
   29. The method of aspect 28 or any other aspect herein wherein the training feature graph parameters of the P training feature graphs are determined according to the methods of any one of aspects 3 to 7.
   30. The method of aspect 29 or any other aspect herein wherein for each high-resolution vertex v of the Vhigh-resolution vertices, determining weights for the weighted radial basis functions (RBFs) in the matrix ϕ based at least in part on a proximity mask which assigns a value of unity for feature edges surrounding the vertex v and decaying values for feature edges that are further from the vertex v.
   31. The method of aspect 30 or any other aspect herein wherein the proximity mask assigns exponentially decaying values for feature edges that are further from the vertex v.
   32. The method of any one of aspects 30 to 31 or any other aspect herein wherein the proximity mask is determined according to an equation of the form:

$${α}_{v , i} = \frac{{\overline{α}}_{v , i}}{{\sum }_{i} {\overline{α}}_{v , i}} , with {\overline{α}}_{v , i} = {e}^{- β ( {L}_{v , i} - {l}_{i} )} \qquad ( 5 )$$

where: lᵢ is a length of the iₜₕ feature edge of the neutral-pose; L_{v,i} is the sum of neutral pose distances from the vertex v to the locations of endpoints of the i^{th} feature edge of the neutral-pose; and β is a configurable scalar parameter which controls a rate of decay.
33. The method of any one of aspects 30 to 32 or any other aspect herein comprising setting the proximity mask for the i^{th} feature edge to zero if it is determined that a computed proximity mask for the i^{th} feature edge is less than a threshold value.
34. The method of aspect 30 or any other aspect herein wherein the proximity mask comprises assigning non-zero values to a configurable number of feature edges that are relatively more proximate to the vertex v and zero values to other feature edges that are relatively more distal from the vertex v.
35. The method of any of aspects 29 to 34 or any other aspect herein, wherein an element (ϕ_{v,k,l}) of the P×P dimensional matrix ϕ of weighted RBFs at a k^{th} column and a l^{th} row is given by an equation of the form:

$${ϕ}_{v , k , l} = γ ( {\sum }_{i = 1}^{F} {{α}_{v , i} ( {( {f}_{k , i} - {f}_{l , i} )}^{{}_{2}} )}^{{}_{{}_{1 / 2}}} \qquad ( 4 )$$

where: γ is an RBF kernel function; ƒ_{k,i} is a training feature graph parameter of the i^{th} feature edge in the k^{th} training pose; ƒ_{l,i} is a training feature graph parameter of the i^{th} feature edge of the l^{th} training pose; and α_{v,i} is a weight assigned to i^{th} feature edge based on its proximity to the high-resolution vertex v.
36. The method of aspect 35 or any other aspect herein wherein the RBF kernel function γ is a biharmonic RBF kernel function.
37. The method of aspect 27 or any other aspect herein wherein determining the approximation model comprises training an approximation model to solve a sparse interpolation problem based at least in part on the training feature graph parameters of the P training feature graphs.
38. The method of aspect 37 or any other aspect herein wherein the training feature graph parameters of the P training feature graphs are determined according to the methods of any one of aspects 3 to 7.
39. The method of any of aspects 35 to 36 or any other aspect herein wherein:
the target feature graph parameters of the target feature graph are determined according to the methods of any one of aspects 8 to 12; and
the method comprises determining the similarity metric ϕ^{v,t} representing the similarity of the target feature graph at the vertex v to each of the P training feature graphs be a P dimensional similarity vector ϕ^{v,t}, where a k^{th} element (ϕₖ^{v,t}) of the similarity vector ϕ^{v,t} according to an equation of the form:

$${ϕ}_{k}^{v , t} = γ ( {\sum }_{i = 1}^{F} {{α}_{v , i} ( {( {f}_{t , i} - {f}_{k , i} )}^{{}_{2}} )}^{{}_{{}_{1 / 2}}} \qquad ( 7 )$$

where: γ is an RBF kernel function; ƒ_{t,i} a target feature graph parameter of the i^{th} feature edge of the target feature graph; ƒ_{k,i} is a training feature graph parameter of the i^{th} feature edge of the training feature graph for the k^{th} training pose; α_{v,i} is a weight assigned to i^{th} feature edge based on its proximity to the high-resolution vertex v; and i (i∈1, 2, . . . F) is an index that describes the number of edges in each of the training feature graphs and the target feature graph.
40. The method of aspect 39 or any other aspect herein wherein determining the plurality of blending weights tᵥ comprises performing an operation of the form tᵥ=w·ϕ^{v,t}, where w is the RBF weight matrix for the high-resolution vertex v and ϕ^{v,t} is the P dimensional similarity vector representing the similarity of the target feature graph at the vertex v to each of the P training feature graphs.
41. The method of any of aspects 23 to 26 or any other aspect herein wherein interpolating the 2D textures of the P training facial poses comprises:
texture querying the 2D textures of the P training facial poses based on the high-resolution pixel in the 2D rendering to obtain interpolated texture values for each of the P training facial poses (tex₁, tex₂, tex₃ . . . tex_{P}), each interpolated texture value interpolated between texture values at a plurality of texels of the 2D texture of a corresponding one of the P training facial poses;
weight-texture querying the 2D space based on the high-resolution pixel in the 2D rendering to obtain a set of interpolated per-pixel blending weights r* (r₁, r₂ . . . r_{P}), which are interpolated between per-pixel blending weights rₙ of a plurality of pixels n in the 2D space.
   42. The method of aspect 41 or any other aspect herein wherein interpolating the 2D textures of the P training facial poses comprises determining the target texture for the high-resolution pixel (textur) according to an equation of the form

$$texture = {tex}_{1} \cdot {r}_{1} + t e {x}_{2} \cdot {r}_{2} + … {tex}_{P} \cdot {r}_{P}$$

where: (tex₁, tex₂, tex₃ . . . tex_{P}) are the interpolated texture values for each of the P training facial poses; and (r₁, r₂ . . . r_{P}) are the set of interpolated per-pixel blending weights r*.
43. The method of any one of aspects 41 to 42 or any other aspect herein wherein texture querying the 2D textures of the P training facial poses based on the high-resolution pixel in the 2D rendering comprises mapping the high-resolution pixel in the 2D rendering to UV space to determine 2D coordinates of the high-resolution pixel in UV space.
44. The method of any one of aspects 41 to 43 or any other aspect herein wherein weight-texture querying the 2D space based on the high-resolution pixel in the 2D rendering comprises mapping the high-resolution pixel in the 2D rendering to the 2D space to determine 2D coordinates of the high-resolution pixel in the 2D space.
45. The method of aspect 22 or any other aspect herein wherein interpolating the 2D textures of the P training facial poses comprises:
texture querying the 2D textures of the P training facial poses based on the high-resolution pixel in the 2D rendering to obtain interpolated texture values for each of the P training facial poses (tex₁, tex₂, tex₃ . . . tex_{P}), each interpolated texture value interpolated between texture values at a plurality of texels of the 2D texture of a corresponding one of the P training facial poses.
   46. The method of aspect 45 or any other aspect herein wherein interpolating the 2D textures of the P training facial poses comprises determining the target texture for the high-resolution pixel (textur) according to an equation of the form

$$texture = {tex}_{1} \cdot {r}_{1} + t e {x}_{2} \cdot {r}_{2} + … {tex}_{P} \cdot {r}_{P}$$

where: (tex₁, tex₂, tex₃ . . . tex_{P}) are the interpolated texture values for each of the P training facial poses; and (r₁, r₂ . . . r_{P}) are the set of interpolated per-pixel blending weights rₙ for the high-resolution pixel in the 2D space of the 2D rendering.
47. The method of any one of aspects 45 to 46 or any other aspect herein wherein texture querying the 2D textures of the P training facial poses based on the high-resolution pixel in the 2D rendering comprises mapping the high-resolution pixel in the 2D rendering to UV space to determine 2D coordinates of the high-resolution pixel in UV space.
48. The method of any one of aspects 1 to 47 or any other aspect herein wherein:
the method is used to render an animation sequence comprising a plurality of animation frames corresponding to a plurality of target facial expressions at an animation frame rate;
steps (a), (d) and (f.1) are performed for the animation sequence as a pre-computation step prior to one or more of steps (b), (c), (e), (f.2) and (g); and
steps (c), (e), (f.2) and (g) are performed in real time upon obtaining corresponding ones of the plurality of target facial expressions, as part of step (b), for the animation sequence.
   49. The method of aspect 48 or any other aspect herein wherein:
the set of per-pixel blending weights rₙ for each pixel n comprises a vector of P elements; and
the method comprises providing corresponding elements of the per-pixel blending weights rₙ to a graphics processor in color channels of one or more corresponding images having N pixels.
   50. The method of any one of aspects 23 to 26, and 41 to 44 or any other aspect herein wherein:
the method is used to render an animation sequence comprising a plurality of animation frames corresponding to a plurality of target facial expressions at an animation frame rate;
steps (a), (d) and (f.1) are performed for the animation sequence as a pre-computation step prior to one or more of steps (b), (c), (e), (f.2) and (g); and
steps (c), (e), (f.2) and (g) are performed in real time upon obtaining corresponding ones of the plurality of target facial expressions, as part of step (b), for the animation sequence;
the set of per-pixel blending weights rₙ for each pixel n comprises a vector of P elements; and
the method comprises providing corresponding elements of the per-pixel blending weights rₙ to a graphics processor in color channels of one or more corresponding low-resolution images having N low-resolution pixels, with a resolution lower than that of the images being rendered.
   51. The method of any one of aspects 49 to 50 or any other aspect herein wherein the color channels of the one or more corresponding low-resolution images comprise red, blue and green (RGB) color channels.
   52. The method of any one of aspects 49 to 51 or any other aspect herein wherein the plurality of P training poses comprises a number P of training poses that is a multiple of 3.
   53. A computer-implemented method for training an approximation model for facial poses which can be used to determine a similarity of a target facial expression to a plurality of training facial poses at each high-resolution vertex v of a set of Vhigh-resolution vertices that define a topology that is common to the target facial expression and the plurality of training facial poses, the method comprising:
obtaining a plurality of P training facial poses, each of the P training facial poses comprising training-pose positions of the V high-resolution vertices in a three-dimensional (3D) coordinate system;
for each of the P training facial poses:
   determining a training feature graph comprising a corresponding plurality of training feature graph parameters, wherein each of the corresponding plurality of training feature graph parameters is based at least in part on one or more primitive parameters determined based at least in part on the training facial pose and a neutral pose selected from among the P training poses;
to thereby obtain P training feature graphs, each of the P training feature graphs comprising a corresponding plurality of training feature graph parameters; and
for each high-resolution vertex v of the Vhigh-resolution vertices:
   solving an equation of the form w=dϕ⁻¹ where:
      d is a P-dimensional identity matrix; and
      ϕ is a P×P dimensional matrix of weighted radial basis functions (RBFs) where each element of ϕ is based at least in part on comparing the training feature graph parameters of the P training feature graphs;
to thereby obtain a P×P dimensional matrix of RBF weights w corresponding to the high-resolution vertex v;
to thereby define an approximation model which comprises a set of VRBF weight matrices w.
   54. The method of aspect 53 or any other aspect herein comprising determining a plurality of low-resolution W handle vertices, where the W handle vertices are a low-resolution subset of the Vhigh-resolution vertices where W<V.
   55. The method of aspect 54 or any other aspect herein wherein determining the training feature graph comprising the corresponding plurality of training feature graph parameters comprises:
determining a training feature graph geometry corresponding to the training facial pose, the training feature graph geometry comprising a plurality of F feature edges defined between the training-pose positions of corresponding pairs of the plurality of low-resolution W handle vertices for the training pose;
determining the plurality of training feature graph parameters, each of the plurality of training feature graph parameters based at least in part on some or all of the F feature edges of the training facial pose and some or all of the feature edges of the neutral pose.
   56. The method of aspect 54 or any other aspect herein wherein determining the training feature graph comprising the corresponding plurality of training feature graph parameters comprises:
determining a training feature graph geometry corresponding to the training facial pose, the training feature graph geometry comprising a plurality of F feature edges defined between the training-pose positions of corresponding pairs of the plurality of low-resolution W handle vertices for the training pose;
determining the plurality of training feature graph parameters to be a plurality of F training feature graph parameters corresponding to the F feature edges, each of the plurality of F training feature graph parameters based at least in part on the corresponding feature edge of the training facial pose and the corresponding feature edge of the neutral pose;
to thereby obtain the P training feature graphs, each of the P training feature graphs comprising a corresponding plurality of F training feature graph parameters.
   57. The method aspect 56 or any other aspect herein wherein determining the plurality of F training feature graph parameters corresponding to the F feature edges comprises, for each of the plurality of F training feature graph parameters, determining the training feature graph parameter using an equation of the form

$${f}_{i} = ( ‖ {p}_{i , 1} - {p}_{i , 2} ‖ - {l}_{i} ) / {l}_{i} \qquad ( 1 )$$

where: ƒᵢ is the i^{th} training feature graph parameter corresponding to the i^{th} feature edge; p_{i,1} and p_{i,2} are the training-pose positions of the handle vertices that define endpoints of ƒᵢ; and lᵢ is a length of the corresponding i^{th} feature edge in the neutral pose.
58. The method of aspect 53 or any other aspect herein wherein determining the training feature graph comprising the corresponding plurality of training feature graph parameters comprises determining one of more of: deformation gradients based at least in part on the training facial pose and the neutral pose; pyramid coordinates based at least in part on the training facial pose and the neutral pose; triangle parameters based at least in part on the training facial pose and the neutral pose; and 1-ring neighbor parameters based at least in part on the training facial pose and the neutral pose.
59. The method of any one of aspects 55 to 57 or any other aspect herein wherein, for each high-resolution vertex v of the V high-resolution vertices, determining weights for the weighted radial basis functions (RBFs) in the matrix ϕ based at least in part on a proximity mask which assigns a value of unity for feature edges surrounding the vertex v and decaying values for feature edges that are further from the vertex v.
60. The method of aspect 59 or any other aspect herein wherein the proximity mask assigns exponentially decaying values for feature edges that are further from the vertex v.
61. The method of any one of aspects 59 to 60 or any other aspect herein wherein the proximity mask is determined according to an equation of the form:

$${α}_{v , i} = \frac{{\overline{α}}_{v , i}}{{\sum }_{i} {\overline{α}}_{v , i}} , with {\overline{α}}_{v , i} = {e}^{- β ( {L}_{v , i} - {l}_{i} )} \qquad ( 6 )$$

where: lᵢ is a length of the iₜₕ feature edge of the neutral-pose; L_{v,i} is the sum of neutral pose distances from the vertex v to the locations of endpoints of the i^{th} feature edge of the neutral-pose; and β is a configurable scalar parameter which controls a rate of decay.
62. The method of any one of aspects 59 to 61 or any other aspect herein comprising setting the proximity mask for the i^{th} feature edge to zero if it is determined that a computed proximity mask for the i^{th} feature edge is less than a threshold value.
63. The method of aspect 59 or any other aspect herein wherein the proximity mask comprises assigning non-zero values to a configurable number of feature edges that are relatively more proximate to the vertex v and zero values to other feature edges that are relatively more distal from the vertex v.
64. The method of any of aspects 55 to 57 and 59 to 63 or any other aspect herein, wherein an element (ϕ_{v,k,l}) of the P×P dimensional matrix ϕ of weighted RBFs at a k^{th} column and a l^{th} row is given by an equation of the form:

$${ϕ}_{v , k , l} = γ ( {\sum }_{i = 1}^{F} {{α}_{v , i} ( {( {f}_{k , i} - {f}_{l , i} )}^{{}_{2}} )}^{{}_{{}_{{}_{1 / 2}}}} \qquad ( 4 )$$

where: γ is an RBF kernel function; ƒ_{k,i} is a training feature graph parameter of the i^{th} feature edge in the k^{th} training pose; ƒ_{l,i} is a training feature graph parameter of the i^{th} feature edge of the l^{th} training pose; and α_{v,i} is a weight assigned to i^{th} feature edge based on its proximity to the high-resolution vertex v.
65. The method of aspect 64 or any other aspect herein wherein the RBF kernel function γ is a biharmonic RBF kernel function.
66. Use of the approximation model of any of aspects 53 to 65 to determine a high-resolution texture for rendering a target facial expression.
67. Use of the approximation model according to aspect 66 comprising any of the features of any of aspects 1 to 52.
68. A system comprising one or more processors configured by suitable software to perform the methods of any of aspects 1 to 67 and/or any parts thereof.
69. Methods comprising any blocks, acts, combinations of blocks and/or acts or sub-combinations of blocks and/or acts described herein.
60. Apparatus and/or systems comprising any features, combinations of features or sub-combinations of features described herein.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

1. A method for determining a high-resolution texture for rendering a target facial expression, the method comprising:
(a) obtaining a plurality of P training facial poses, each of the P training facial poses comprising:
V high-resolution vertices and training-pose positions of the Vhigh-resolution vertices in a three-dimensional (3D) coordinate system; and
at least one two-dimensional (2D) texture;
(b) obtaining a target facial expression, the target facial expression comprising the Vhigh-resolution vertices and target-expression positions of the V high-resolution vertices in the 3D coordinate system;
(c) determining a target feature graph comprising a plurality of target feature graph parameters for the target facial expression based at least in part on the target facial expression and a neutral pose selected from among the P training poses;
(d) determining training feature graphs comprising pluralities of training feature graph parameters for the P training facial poses, each of the training feature graphs based at least in part on one of the P training facial poses and the neutral pose;
(e) for each of a plurality of high-resolution vertices v from among the V high-resolution vertices, determining a plurality of blending weights tᵥ based at least in part on: an approximation model trained using the P training facial poses; and a similarity metric ϕ^{v,t} which represents a similarity of the target feature graph at the vertex v to each of the training feature graphs;
(f) for each pixel n in a plurality of N pixels in a 2D space:
(f.1) determining one or more corresponding vertices from among the plurality of high-resolution vertices v that correspond with the pixel n based at least in part on 2D coordinates of the pixel n in the 2D space and a mapping of the plurality of high-resolution vertices v to the 2D space which provides 2D coordinates of the plurality of high-resolution vertices v in the 2D space; and
(f.2) determining a set of per-pixel blending weights rₙ for the pixel n based at least in part on the blending weights tᵥ for the one or more corresponding vertices, the set of per-pixel blending weights rₙ comprising a weight for each of the P training facial poses; and
(g) for each high-resolution pixel in a 2D rendering of the target facial expression, interpolating the 2D textures of the P training facial poses based at least in part on the per-pixel blending weights rₙ to thereby provide a target texture for the high-resolution pixel.

2. The method of claim 1 wherein determining the training feature graphs for the P training poses comprises determining a plurality of W low-resolution handle vertices, where the W handle vertices are a low-resolution subset of the V high-resolution vertices where W<V.

3. The method of claim 2 wherein determining the training feature graphs for the P training poses comprises, for each of the P training facial poses:
determining a training feature graph geometry corresponding to the training facial pose, the training feature graph geometry comprising a plurality of F feature edges defined between the training-pose positions of corresponding pairs of the plurality of low-resolution W handle vertices for the training pose;
determining the plurality of training feature graph parameters to be a plurality of F training feature graph parameters corresponding to the F feature edges, each of the plurality of F training feature graph parameters based at least in part on the corresponding feature edge of the training facial pose and the corresponding feature edge of the neutral pose;
to thereby obtain the P training feature graphs, each of the P training feature graphs comprising a corresponding plurality of F training feature graph parameters.

4. The method claim 3 wherein determining the plurality of F training feature graph parameters corresponding to the F feature edges comprises, for each of the plurality of F training feature graph parameters, determining the training feature graph parameter using an equation of the form
$${f}_{i} = ( ‖ {p}_{i , 1} - {p}_{i , 2} ‖ - {l}_{i} ) / {l}_{i} \qquad ( 1 )$$
where: ƒᵢ is the i^{th} training feature graph parameter corresponding to the i^{th} feature edge; p_{i,1} and p_{i,2} are the training-pose positions of the handle vertices that define endpoints of ƒᵢ; and lᵢ is a length of the corresponding i^{th} feature edge in the neutral pose.

5. The method of claim 2 wherein determining the training feature graphs for the P training poses comprises, for each of the P training facial poses:
determining a training feature graph geometry corresponding to the training facial pose, the training feature graph geometry comprising a plurality of F feature edges defined between the training-pose positions of corresponding pairs of the plurality of low-resolution W handle vertices for the training pose;
determining the plurality of training feature graph parameters, each of the plurality of training feature graph parameters based at least in part on some or all of the F feature edges of the training facial pose and some or all of the feature edges of the neutral pose;
to thereby obtain the P training feature graphs, each of the P training feature graphs comprising a corresponding plurality of training feature graph parameters.

6. The method of claim 1 wherein determining the training feature graphs for the P training poses comprises, for each of the P training facial poses:
determining the plurality of training feature graph parameters, each of the plurality of training graph feature parameters based at least in part on one or more primitive parameters determined based at least in part on the training facial pose and the neutral pose;
to thereby obtain the P training feature graphs, each of the P training feature graphs comprising a corresponding plurality of training feature graph parameters.

7. The method of claim 6 wherein determining the plurality of training feature graph parameters comprises determining one or more of: deformation gradients based at least in part on the training facial pose and the neutral pose; pyramid coordinates based at least in part on the training facial pose and the neutral pose; triangle parameters based at least in part on the training facial pose and the neutral pose; and 1-ring neighbor parameters based at least in part on the training facial pose and the neutral pose.

8. The method of claim 2 wherein determining the target feature graph comprises:
determining a target feature graph geometry corresponding to the target facial expression, the target feature graph geometry comprising a plurality of F feature edges defined between the target-expression positions of corresponding pairs of the plurality of low-resolution W handle vertices for the target expression;
determining the plurality of target feature graph parameters to be a plurality of F target feature graph parameters corresponding to the F feature edges, each of the plurality of F target feature graph parameters based at least in part on the corresponding feature edge of the target facial expression and the corresponding feature edge of the neutral pose;
to thereby obtain the target feature graph comprising the plurality of F target feature graph parameters.

9. The method claim 8 wherein determining the plurality of F target feature graph parameters corresponding to the F feature edges comprises, for each of the plurality of F target feature graph parameters, determining the target feature graph parameter using an equation of the form
$${f}_{i} = ( ‖ {p}_{i , 1} - {p}_{i , 2} ‖ - {l}_{i} ) / {l}_{i} \qquad ( 1 )$$
where: ƒᵢ is the i^{th} target feature graph parameter corresponding to the i^{th} feature edge; p_{i,1} and p_{i,2} are the target-expression positions of the handle vertices that define endpoints of ƒᵢ; and lᵢ is a length of the corresponding i^{th} feature edge in the neutral pose.

10. The method of claim 5 wherein determining the target feature graph comprises:
determining a target feature graph geometry corresponding to the target facial expression, the target feature graph geometry comprising a plurality of F feature edges defined between the target-expression positions of corresponding pairs of the plurality of low-resolution W handle vertices for the target facial expression;
determining the plurality of target feature graph parameters, each of the plurality of target feature graph parameters based at least in part on some or all of the F feature edges of the target facial expression and some or all of the feature edges of the neutral pose;
to thereby obtain the target feature graph comprising the plurality of target feature graph parameters.

11. The method of claim 6 wherein determining the target feature graph comprises:
determining a plurality of target feature graph parameters, each of the plurality of target graph feature parameters based at least in part on one or more primitive parameters determined based on the target facial expression and the neutral pose;
to thereby obtain the target feature graph comprising the plurality of target feature graph parameters.

12. The method of claim 11 wherein determining the plurality of target feature graph parameters comprises determining one or more of: deformation gradients based at least in part on the target facial expression and the neutral pose; pyramid coordinates based at least in part on the target facial expression and the neutral pose; triangle parameters based at least in part on the target facial expression and the neutral pose; and 1-ring neighbor parameters based at least in part on the target facial expression and the neutral pose.

13. The method of claim 1 wherein determining the one or more corresponding vertices from among the plurality of high-resolution vertices v that correspond with the pixel n is based at least in part on a proximity of the 2D coordinates of the one or more corresponding vertices to the 2D coordinates of the pixel n.

14. The method of claim 13 wherein determining the one or more corresponding vertices from among the plurality of high-resolution vertices v that correspond with the pixel n comprises determining the three vertices with 2D coordinates most proximate to the 2D coordinates of the pixel n, to thereby define a triangle around the pixel n in the 2D space.

15. The method of claim 13 wherein determining the one or more corresponding vertices from among the plurality of high-resolution vertices v that correspond with the pixel n comprises determining barycentric coordinates for the triangle relative to the 2D coordinates of the pixel n.

16. The method of claim 13 wherein determining the one or more corresponding vertices from among the plurality of high-resolution vertices v that correspond with the pixel n comprises determining the one vertex with 2D coordinates most proximate to the 2D coordinates of the pixel n.

17. The method of claim 1 comprising selecting the plurality of high-resolution vertices v from among the V high-resolution vertices to be a union of the one or more high-resolution vertices determined to correspond with each pixel n in the plurality of N pixels; and wherein selecting the plurality of high-resolution vertices v from among the Vhigh-resolution vertices is performed prior to step (e) so that step (e) is performed only for the selected plurality of high-resolution vertices v from among the V high-resolution vertices.

18. The method of claim 1 comprising selecting the plurality of high-resolution vertices v from among the V high-resolution vertices to be all of the V high-resolution vertices.

19. The method of claim 15 wherein determining the set of per-pixel blending weights rₙ for the pixel n comprises determining the set of per-pixel blending weights rₙ for the pixel n based at least in part on the blending weights tᵥ for the three vertices that define the triangle around the pixel n in the 2D space and the barycentric coordinates of the triangle relative to the 2D coordinates of the pixel n.

20. The method of claim 15 wherein determining the set of per-pixel blending weights rₙ for the pixel n comprises performing an operation of the form rₙ═γ_{A}t_{A}+γ_{B}t_{B}+γ_{C}t_{C} where t_{A}, t_{B}, t_{C} represent the blending weights tᵥ determined in step (e) for the three vertices that define the triangle around the pixel n in the 2D space and γ_{A}, γ_{B}, γ_{C} represent the barycentric coordinates for the triangle relative to the 2D coordinates of the pixel n.
